(19) United States
(12) Patent Application Publication
(10) Pub. No.: US 2025/0023658 A1
(43) Pub. Date: Jan. 16, 2025

(54) COMMUNICATION METHOD AND RELATED APPARATUS

(71) Applicant: HUAWEI TECHNOLOGIES CO., LTD., Shenzhen (CN)

(72) Inventors: Jian YU, Shenzhen (CN); Mengshi HU, Shenzhen (CN); Jiahui LI, Shenzhen (CN); Mengyao MA, Shenzhen (CN); Ming GAN, Shenzhen (CN)

(21) Appl. No.: 18/898,996

(22) Filed: Sep. 27, 2024

Related U.S. Application Data
(63) Continuation of application No. PCT/CN2023/079819, filed on Mar. 6, 2023.

(30) Foreign Application Priority Data
Mar. 29, 2022 (CN) 202210318311.7

(51) Int. Cl. H04L 1/00

(52) U.S. Cl. CPC H04L 1/0033; H04L 1/0003

(57) ABSTRACT

This application provides a communication method and a related apparatus. The method includes: generating a trigger frame, where the trigger frame includes a user information field corresponding to one or more users; the one or more users include a first user using joint source and channel coding; and the first user corresponds to a plurality of user information fields, and a user information field corresponding to the first user indicates a layer frequency domain resource of the first user at a source layer, or the first user corresponds to one user information field, and the one user information field corresponding to the first user indicates a total frequency domain resource of the first user at all source layers; and sending the trigger frame, to receive a trigger-based physical layer protocol data unit of the first user.

### CROSS-REFERENCE TO RELATED APPLICATIONS

This application is a continuation of International Application No. PCT/CN2023/079819, filed on Mar. 6, 2023, which claims priority to Chinese Patent Application No. 202210318311.7, filed on Mar. 29, 2022. The disclosures of the aforementioned applications are hereby incorporated by reference in their entireties.

### TECHNICAL FIELD

This application relates to the field of communication technologies, and in particular, to a communication method and a related apparatus.

### BACKGROUND

At present, a joint source and channel coding (joint source and channel coding, JSCC) technology is proposed, to improve quality of wireless video or picture transmission.

Usually, a station performs uplink data transmission after obtaining transmission permission through channel contention, for example, a channel is preempted in an enhanced distributed channel access (enhanced distributed channel access, EDCA) manner. For example, a trigger-based scheduling uplink transmission method is introduced in 802.11ax, and the trigger-based scheduling uplink transmission method is inherited in 802.11be.

However, JSCC transmission implemented based on a trigger frame is still in a blank phase.

### SUMMARY

This application provides a communication method and a related apparatus, to implement trigger-based joint source and channel coding transmission.

According to a first aspect, a communication method is provided. The method includes: generating a trigger frame, where the trigger frame includes a user information field corresponding to one or more users, and the one or more users include a first user using joint source and channel coding; and the first user corresponds to a plurality of user information fields, and a user information field corresponding to the first user indicates a layer frequency domain resource of the first user at a source layer; or the first user corresponds to one user information field, and the one user information field corresponding to the first user indicates a total frequency domain resource of the first user at all source layers; sending the trigger frame; and receiving a trigger-based physical layer protocol data unit of the first user, where the trigger-based physical layer protocol data unit includes joint source and channel coding data on a layer frequency domain resource of the first user.

According to a second aspect, a communication method is provided. The method includes: receiving a trigger frame, where the trigger frame includes a user information field corresponding to one or more users, and the one or more users include a first user using joint source and channel coding; and the first user corresponds to a plurality of user information fields, and a user information field corresponding to the first user indicates a layer frequency domain resource of the first user at a source layer; or the first user corresponds to one user information field, and the one user information field corresponding to the first user indicates a total frequency domain resource of the first user at all source layers; and sending a trigger-based physical layer protocol data unit of the first user, where the trigger-based physical layer protocol data unit includes joint source and channel coding data on a layer frequency domain resource of the first user.

According to a third aspect, a communication apparatus is provided. The communication apparatus includes a transceiver module and a processing module. The processing module is configured to generate a trigger frame, where the trigger frame includes a user information field corresponding to one or more users, and the one or more users include a first user using joint source and channel coding; and the first user corresponds to a plurality of user information fields, and a user information field corresponding to the first user indicates a layer frequency domain resource of the first user at a source layer; or the first user corresponds to one user information field, and the one user information field corresponding to the first user indicates a total frequency domain resource of the first user at all source layers. The transceiver module is configured to send the trigger frame. The transceiver module is configured to receive a trigger-based physical layer protocol data unit of the first user, where the trigger-based physical layer protocol data unit includes joint source and channel coding data on a layer frequency domain resource of the first user.

According to a fourth aspect, a communication apparatus is provided. The communication apparatus includes a transceiver module. The transceiver module is configured to receive a trigger frame, where the trigger frame includes a user information field corresponding to one or more users, and the one or more users include a first user using joint source and channel coding; and the first user corresponds to a plurality of user information fields, and a user information field corresponding to the first user indicates a layer frequency domain resource of the first user at a source layer; or the first user corresponds to one user information field, and the one user information field corresponding to the first user indicates a total frequency domain resource of the first user at all source layers. The transceiver module is configured to send a trigger-based physical layer protocol data unit of the first user, where the trigger-based physical layer protocol data unit includes joint source and channel coding data on a layer frequency domain resource of the first user.

For any one of the first aspect to the fourth aspect, it can be learned that a user using JSCC transmission may correspond to one or more user information fields in the trigger frame. When the user using JSCC transmission corresponds to one user information field, the total frequency domain resource at all the source layers may be allocated to the user, so that the trigger-based physical layer protocol data unit may include joint source and channel coding data on a layer frequency domain resource. This implements trigger-based joint source and channel coding transmission, reduces a number of user information fields, and further reduces overheads. When the user using JSCC transmission corresponds to a plurality of user information fields, a user information field indicates a layer frequency domain resource at a source layer, so that the trigger-based physical layer protocol data unit may include joint source and channel coding data on the layer frequency domain resource. This implements trigger-based joint source and channel coding transmission. In addition, for trigger-based joint source and channel coding transmission, a corresponding trigger-based physical layer protocol data unit is designed to enable an uplink multi-user JSCC transmission solution. This improves transmission efficiency of a system, and reduces a transmission delay.

Optionally, with reference to any one of the first aspect to the fourth aspect, the trigger frame indicates that there is a user using joint source and channel coding in the one or more users. It can be learned that, because the trigger frame indicates that there is the user using joint source and channel coding in the one or more users, a user that receives the trigger frame may learn that there is the user using joint source and channel coding.

Optionally, with reference to any one of the first aspect to the fourth aspect, the trigger frame further includes a common information field, and the common information field indicates that there is a user using joint source and channel coding in the one or more users. Alternatively, the trigger frame further includes a special user information field, and the special user information field indicates that there is a user using joint source and channel coding in the one or more users. It can be learned that the common information field or the special user information field indicates that there is the user using joint source and channel coding in the one or more users. Because the common information field or the special user information field is a field that can be read by all users, all users that receive the trigger frame may learn that there is the user using joint source and channel coding.

Optionally, with reference to any one of the first aspect to the fourth aspect, a user information field corresponding to the first user indicates a modulation and coding scheme of the first user at a source layer, or a user information field corresponding to the first user indicates the first user to select a modulation and coding scheme of a source layer. It can be learned that, after reading the user information field corresponding to the user in the trigger frame, the user using JSCC transmission may further learn of a modulation and coding scheme of the source layer, or may select the modulation and coding scheme of the source layer.

Optionally, with reference to any one of the first aspect to the fourth aspect, a user information field corresponding to the first user further indicates that the first user uses joint source and channel coding transmission. It can be seen that, after reading the user information field corresponding to the user in the trigger frame, the user using JSCC transmission may further learn that the user is the user using joint source and channel coding transmission.

Optionally, with reference to any one of the first aspect to the fourth aspect, the first user corresponds to a plurality of user information fields, and that the first user uses joint source and channel coding transmission is indicated by the plurality of user information fields corresponding to the first user that use a same association identifier field. It can be learned that, when the user using JSCC transmission corresponds to the plurality of user information fields, that the user is the user using joint source and channel coding transmission is implicitly indicated by the plurality of user information fields that use the same association identifier field. This reduces overheads.

Optionally, with reference to any one of the first aspect to the fourth aspect, the first user corresponds to the plurality of user information fields, a number of source layers of the first user is equal to a number of user information fields that use the same association identifier field, and the association identifier field indicates an association identifier of the first user. It can be learned that when the user using JSCC transmission corresponds to the plurality of user information fields, the number of user information fields that use the same association identifier field may implicitly indicate the number of source layers of the first user. This reduces overheads.

Optionally, with reference to any one of the first aspect to the fourth aspect, the first user corresponds to one user information field, the first user corresponds to the one user information field, and the one user information field corresponding to the first user further indicates at least one of the following: a number of source layers of the first user and a layer frequency domain resource of the first user at each source layer; or a layer frequency domain resource of the first user at each source layer is a predefined frequency domain resource. It can be seen that, when the user using JSCC transmission corresponds to one user information field, the user may learn of, by reading the user information field, the number of all source layers of the user and/or the layer frequency domain resource of the user at each source layer; or the layer frequency domain resource of the user at each source layer is the predefined frequency domain resource. Therefore, no additional indication is required in the trigger frame. This reduces overheads.

Optionally, with reference to any one of the first aspect to the fourth aspect, the first user corresponds to the plurality of user information fields. The trigger-based physical layer protocol data unit includes a first signal field of the first user, the first signal field of the first user indicates at least one of the following: a joint source and channel coding parameter of one source layer corresponding to the first user, and a joint source and channel coding parameter shared by all the source layers of the first user, and the first signal field of the first user is on a layer frequency domain resource at the one source layer corresponding to the first user; or the trigger-based physical layer protocol data unit includes a data field of the first user, the data field of the first user indicates at least one of the following: a joint source and channel coding parameter of one source layer corresponding to the first user, and a joint source and channel coding parameter shared by all the source layers of the first user, and the data field of the first user is on a layer frequency domain resource at the one source layer corresponding to the first user. It can be learned that, when the user using JSCC transmission corresponds to the plurality of user information fields, the trigger-based physical layer protocol data unit may include the first signal field or data field at one source layer of the user, so that a user that receives the trigger-based physical layer protocol data unit can learn of, by reading the first signal field or data field of the user, a joint source and channel coding parameter required for reading joint source and channel coding data of the user at the source layer.

Optionally, with reference to any one of the first aspect to the fourth aspect, the first user corresponds to the one user information field. The trigger-based physical layer protocol data unit includes a first signal field of the first user, the first signal field of the first user indicates at least one of the following: a joint source and channel coding parameter of one source layer corresponding to the first user, and a joint source and channel coding parameter shared by all the source layers of the first user, and the first signal field of the first user is on a layer frequency domain resource at the one source layer corresponding to the first user; or the trigger-based physical layer protocol data unit includes a first signal field of the first user, the first signal field of the first user indicates at least one of the following: a joint source and channel coding parameter of each source layer of the first user, and a joint source and channel coding parameter shared by all the source layers of the first user, and the first signal field of the first user is on the total frequency domain resource of the first user at all the source layers; or the trigger-based physical layer protocol data unit includes a first signal field of the first user, the first signal field of the first user includes a signal A field and at least one signal B field, the signal A field is on the total frequency domain resource of the first user at all the source layers, one signal B field is on a layer frequency domain resource of one source layer corresponding to the first user, the signal A field indicates a joint source and channel coding parameter shared by all the source layers of the first user, and the one signal B field indicates a joint source and channel coding parameter of the one source layer corresponding to the first user. It can be learned that, when a user using JSCC transmission corresponds to one user information field, the trigger-based physical layer protocol data unit may include a first signal field at one source layer or all source layers of the user, so that a user that receives the trigger-based physical layer protocol data unit can learn of, by reading the first signal field of the user, a joint source and channel coding parameter required for reading joint source and channel coding data of the user at the source layer. Alternatively, when the user using JSCC transmission corresponds to one user information field, the trigger-based physical layer protocol data unit may include a first signal field of the user, and the first signal field of the user includes a signal A field and at least one signal B field. Because the signal A field is on the total frequency domain resource of the user at all the source layers, parameters indicated by the signal A field are common parameters corresponding to different source layers. The signal B field is on the layer frequency domain resource at the source layer corresponding to the user, that is, a parameter indicated by the signal B field is a private parameter corresponding to the source layer, so that a user that receives the trigger-based physical layer protocol data unit can separately read a parameter required for parsing each source layer of the user, thereby reducing complexity of reading the signal field.

Optionally, with reference to any one of the first aspect to the fourth aspect, the first signal field of the first user further indicates at least one of the following: a number of all source layers of the first user and an identifier of a source layer corresponding to the first user. It can be learned that, the user that receives the trigger-based physical layer protocol data unit may further learn of at least one of the following: the number of all source layers of the user using JSCC transmission, and the identifier of the source layer corresponding to the user.

Optionally, with reference to any one of the first aspect to the fourth aspect, the first signal field of the first user further includes a layer resource assignment field, and the layer resource assignment field indicates at least one of the following: the number of source layers of the first user and the layer frequency domain resource of the first user at each source layer; or the layer frequency domain resource of the first user at each source layer is the predefined frequency domain resource. It can be learned that the user that receives the trigger-based physical layer protocol data unit may further learn of, by using the first signal field of the user using JSCC transmission, at least one of the following: the number of source layers of the user and the layer frequency domain resource of the user at each source layer. Alternatively, because the layer frequency domain resource of the user at each source layer is the predefined frequency domain resource, no additional indication is required in the trigger-based physical layer protocol data unit. This reduces overheads. In addition, the user that receives the trigger-based physical layer protocol data unit may perform decoding based on a fixed frequency domain resource size.

Optionally, in any one of the first aspect to the fourth aspect, the first signal field of the first user is after a universal signal field and before a short training field, the universal signal field is on the total frequency domain resource of the first user at all the source layers, and the short training field is on the layer frequency domain resource at the one source layer corresponding to the first user; or the first signal field of the first user is after a long training field and before a data field, and the long training field and the data field are on the layer frequency domain resource at the one source layer corresponding to the first user. It can be learned that two trigger-based physical layer protocol data units in different formats are implemented. In addition, because the first signal field of the user using JSCC transmission is after the long training field and before the data field, and the long training field and the data field are on the layer frequency domain resource at the one source layer corresponding to the first user, a user not using JSCC transmission learns that a first signal field of the user not using JSCC transmission does not need to be transmitted when there is the user using JSCC transmission, thereby reducing overheads. In addition, a data field of the user not using JSCC transmission can transmit more data, thereby improving transmission efficiency.

According to a fifth aspect, a communication method is provided. The method includes: generating a trigger frame, where the trigger frame indicates a bandwidth allocated to a user, and the trigger frame further indicates at least one of the following: the trigger frame is a single-user trigger frame, and the user performs joint source and channel coding transmission through a non-trigger-based physical layer protocol data unit; sending the trigger frame; and receiving the non-trigger-based physical layer protocol data unit, where the non-trigger-based physical layer protocol data unit includes joint source and channel coding data on the bandwidth allocated to the user.

According to a sixth aspect, a communication method is provided. The method includes: receiving a trigger frame, where the trigger frame indicates a bandwidth allocated to a user, and the trigger frame further indicates at least one of the following: the trigger frame is a single-user trigger frame, and the user performs joint source and channel coding transmission through a non-trigger-based physical layer protocol data unit; and sending the non-trigger-based physical layer protocol data unit, where the non-trigger-based physical layer protocol data unit includes joint source and channel coding data on the bandwidth allocated to the user.

According to a seventh aspect, a communication apparatus is provided. The communication apparatus includes a transceiver module and a processing module. The processing module is configured to generate a trigger frame, where the trigger frame indicates a bandwidth allocated to a user, and the trigger frame further indicates at least one of the following: The trigger frame is a single-user trigger frame, and the user performs joint source and channel coding transmission through a non-trigger-based physical layer protocol data unit. The transceiver module is configured to send the trigger frame. The transceiver module is configured to receive the non-trigger-based physical layer protocol data unit, where the non-trigger-based physical layer protocol data unit includes joint source and channel coding data on the bandwidth allocated to the user. According to an eighth aspect, a communication apparatus is provided. The communication apparatus includes a transceiver module. The transceiver module is configured to receive a trigger frame, where the trigger frame indicates a bandwidth allocated to a user, and the trigger frame further indicates at least one of the following: The trigger frame is a single-user trigger frame, and the user performs joint source and channel coding transmission through a non-trigger-based physical layer protocol data unit. The transceiver module is configured to send the non-trigger-based physical layer protocol data unit, where the non-trigger-based physical layer protocol data unit includes joint source and channel coding data on the bandwidth allocated to the user.

It can be learned that in any one of the fifth aspect to the eighth aspect, because the trigger frame further indicates at least one of the following: the trigger frame is the single-user trigger frame, and the user performs joint source and channel coding transmission through the non-trigger-based physical layer protocol data unit, a user that receives the trigger frame may send the non-trigger-based physical layer protocol data unit, where the non-trigger-based physical layer protocol data unit includes the joint source and channel coding data on the bandwidth allocated to the user. This implements uplink single-user JSCC transmission. In addition, because the trigger frame is the single-user trigger frame, allocation of resources between users does not need to be considered, and alignment between fields or OFDM symbols, power control, and the like do not need to be considered. This reduces overheads. In addition, a user that receives the non-trigger-based physical layer protocol data unit may perform decoding based on a unified frequency domain resource size.

Optionally, with reference to any one of the fifth aspect to the eighth aspect, the trigger frame includes a common information field, and the common information field indicates at least one of the following: The trigger frame is the single-user trigger frame, and the user performs joint source and channel coding transmission through the non-trigger-based physical layer protocol data unit. Alternatively, the trigger frame includes a special user information field, and the special user information field indicates at least one of the following: The trigger frame is the single-user trigger frame, and the user performs joint source and channel coding transmission through the non-trigger-based physical layer protocol data unit. Alternatively, the trigger frame includes a user information field corresponding to the user, and the user information field indicates at least one of the following: The trigger frame is the single-user trigger frame, and the user performs joint source and channel coding transmission through the non-trigger-based physical layer protocol data unit. Alternatively, the trigger frame includes a receiver address field, and the receiver address field indicates at least one of the following: The trigger frame is the single-user trigger frame, and the user performs joint source and channel coding transmission through the non-trigger-based physical layer protocol data unit. It can be learned that the user that receives the trigger frame may learn of, by reading the common information field, or the special user information field, or the user information field corresponding to the user, or the receiver address field, at least one of the following: the trigger frame is the single-user trigger frame, and the user performs joint source and channel coding transmission through the non-trigger-based physical layer protocol data unit, to send the non-trigger-based physical layer protocol data unit, where the non-trigger-based physical layer protocol data unit includes the joint source and channel coding data on the bandwidth allocated to the user. This implements uplink single-user JSCC transmission.

According to a ninth aspect, a chip is provided. The chip includes at least one logic circuit and an input/output interface. The logic circuit is configured to read and execute stored instructions. When the instructions are run, the chip is enabled to perform the method according to any one of the first aspect, the second aspect, the fifth aspect, or the sixth aspect.

According to a tenth aspect, a computer-readable storage medium is provided. The computer-readable storage medium stores a computer program. The computer program includes program instructions, and when the program instructions are executed by a computer, the computer is enabled to perform the method according to any one of the first aspect, the second aspect, the fifth aspect, or the sixth aspect.

According to an eleventh aspect, a communication apparatus is provided, including a processor and a transceiver. The processor is configured to support the communication apparatus in performing a corresponding function in the method according to the first aspect, the second aspect, the fifth aspect, or the sixth aspect. The transceiver is configured to support communication between the communication apparatus and a communication apparatus other than the communication apparatus. The communication apparatus may further include a memory. The memory is configured to be coupled to the processor, and the memory stores program instructions and data that are necessary for the communication apparatus. The transceiver may be integrated into the communication apparatus or independent of the communication apparatus. This is not limited herein.

According to a twelfth aspect, a computer program product including instructions is provided, where when the computer program product runs on a computer, the computer is enabled to perform the method according to any one of the first aspect, the second aspect, the fifth aspect, or the sixth aspect.

According to a thirteenth aspect, a communication system is provided, including one or more of the following: the first device for performing the method according to either the first aspect or the fifth aspect, and the second device for performing the method according to either the second aspect or the sixth aspect.

### BRIEF DESCRIPTION OF DRAWINGS

The following briefly describes accompanying drawings used for describing embodiments.

FIG. 1 shows a procedure of a conventional data transmission solution;

FIG. 2A and FIG. 2B are a schematic flowchart of a joint source and channel coding data transmission solution;

FIG. 3 shows a solution in which an access point triggers uplink multi-user transmission in 802.11be;

FIG. 4A and FIG. 4B show a frame structure of a trigger frame in 802.11be;

FIG. 5 is a diagram of a network architecture of a WLAN according to an embodiment of this application;

FIG. 6 is a diagram of a hardware structure applicable to a communication apparatus according to an embodiment of this application;

FIG. 7 is a schematic flowchart in which one or more users perform trigger-based JSCC transmission according to an embodiment of this application;

FIG. 8 is a schematic flowchart in which a single user performs non-trigger-based JSCC transmission according to an embodiment of this application;

FIG. 9A and FIG. 9B show a frame structure of a trigger frame in a scenario in which one or more users perform trigger-based JSCC transmission according to an embodiment of this application;

FIG. 10 shows a frame structure of a trigger-based physical layer protocol data unit according to an embodiment of this application in a case in which the frame structure of the trigger frame shown in FIG. 9A and FIG. 9B is used;

FIG. 11 shows a frame structure of another trigger-based physical layer protocol data unit according to an embodiment of this application in a case in which the frame structure of the trigger frame shown in FIG. 9A and FIG. 9B is used;

FIG. 12 shows a frame structure of another trigger-based physical layer protocol data unit according to an embodiment of this application in a case in which the frame structure of the trigger frame shown in FIG. 9A and FIG. 9B is used;

FIG. 13 shows a frame structure of another trigger-based physical layer protocol data unit according to an embodiment of this application in a case in which the frame structure of the trigger frame shown in FIG. 9A and FIG. 9B is used;

FIG. 14 shows a frame structure of another trigger-based physical layer protocol data unit according to an embodiment of this application in a case in which the frame structure of the trigger frame shown in FIG. 9A and FIG. 9B is used;

FIG. 15 shows a frame structure of another trigger-based physical layer protocol data unit according to an embodiment of this application in a case in which the frame structure of the trigger frame shown in FIG. 9A and FIG. 9B is used;

FIG. 16 shows a frame structure of a trigger-based physical layer protocol data unit during carrying different source layers on a time-frequency resource according to an embodiment of this application;

FIG. 17A and FIG. 17B show a frame structure of a trigger frame in a scenario in which a single user performs non-trigger-based JSCC transmission according to an embodiment of this application;

FIG. 18 shows a frame structure of a non-trigger-based physical layer protocol data unit according to an embodiment of this application in a case in which the frame structure of the trigger frame shown in FIG. 17A and FIG. 17B is used;

FIG. 19 shows a frame structure of another non-trigger-based physical layer protocol data unit according to an embodiment of this application in a case in which the frame structure of the trigger frame shown in FIG. 17A and FIG. 17B is used;

FIG. 20 shows a frame structure of another non-trigger-based physical layer protocol data unit according to an embodiment of this application in a case in which the frame structure of the trigger frame shown in FIG. 17A and FIG. 17B is used;

FIG. 21 shows a frame structure of another non-trigger-based physical layer protocol data unit according to an embodiment of this application in a case in which the frame structure of the trigger frame shown in FIG. 17A and FIG. 17B is used;

FIG. 22 shows a frame structure of a non-trigger-based physical layer protocol data unit during carrying different source layers on a time-frequency resource according to an embodiment of this application in a case in which the frame structure of the trigger frame shown in FIG. 17A and FIG. 17B is used;

FIG. 23 shows a frame structure of another non-trigger-based physical layer protocol data unit according to an embodiment of this application in a case in which the frame structure of the trigger frame shown in FIG. 17A and FIG. 17B is used; and

FIG. 24 is a diagram of a structure of a communication apparatus according to an embodiment of this application.

### DESCRIPTION OF EMBODIMENTS

The following describes the technical solutions in embodiments of this application with reference to accompanying drawings in embodiments of this application. The terms “system” and “network” may be used interchangeably in embodiments of this application. Unless otherwise specified, “/” indicates an “or” relationship between associated objects. For example, A/B may indicate A or B. In this application, “and/or” describes only an association relationship between associated objects and indicates that three relationships may exist. For example, A and/or B may indicate the following three cases: Only A exists, both A and B exist, and only B exists, where A or B may be singular or plural. In addition, in the descriptions of this application, “a plurality of” means two or more than two unless otherwise specified. “At least one of the following items (pieces)” or a similar expression thereof means any combination of these items, including a singular item (piece) or any combination of plural items (pieces). For example, at least one item (piece) of a, b, or c may indicate a, b, c, a and b, a and c, b and c, or a, b, and c, where a, b, and c may be singular or plural. In addition, to clearly describe the technical solutions in embodiments of this application, the terms such as “first” and “second” are used in embodiments of this application to distinguish between same items or similar items that provide basically same network elements or purposes. A person skilled in the art may understand that the terms such as “first” and “second” do not limit a number or an execution sequence, and the terms such as “first” and “second” do not indicate a definite difference.

Reference to “an embodiment”, “some embodiments”, or the like described in embodiments of this application means that one or more embodiments of this application include a specific feature, structure, or characteristic described with reference to embodiments. Therefore, statements such as “in one embodiment”, “in some embodiments”, “in some other embodiments”, and “in other embodiments” that appear at different places in this specification do not necessarily mean referring to a same embodiment. Instead, the statements mean “one or more but not all of embodiments”, unless otherwise specifically emphasized in another manner. The terms “include”, “contain”, “have”, and variants thereof all mean “include but are not limited to”, unless otherwise specifically emphasized in another manner.

The objectives, technical solutions, and beneficial effect of this application are further described in detail in the following specific implementations. It should be understood that the following descriptions are merely specific implementations of this application, but are not intended to limit the protection scope of this application. Any modification, equivalent replacement, improvement, or the like made based on technical solutions of this application shall fall within the protection scope of this application.

In embodiments of this application, unless otherwise stated or there is a logic conflict, terms and/or descriptions in different embodiments are consistent and may be mutually referenced, and technical features in different embodiments may be combined based on an internal logical relationship thereof, to form a new embodiment.

The following describes some nouns used in this application. It may be understood that when the following nouns are used in other parts of this application, no explanation or description is provided subsequently.

### 1. Joint Source and Channel Coding (Joint Source and Channel Coding, JSCC) Solution

With development of information technologies and advancement of the society, people have increasing requirements for information and put forward higher requirements for enjoying comprehensive services such as a voice, data, a picture, and a video, and different types of multimedia services anytime and anywhere. Therefore, multimedia communication has become a focus of people's attention. A video is an important part of multimedia data, is exact, real-time, visual, concrete, vivid, and the like, brings visual experience to users, and greatly enriches traditional services. In the next few years, a wireless video service will have a broader development prospect. Therefore, a wireless video coding and transmission technology becomes a research hotspot in a current multimedia communication field.

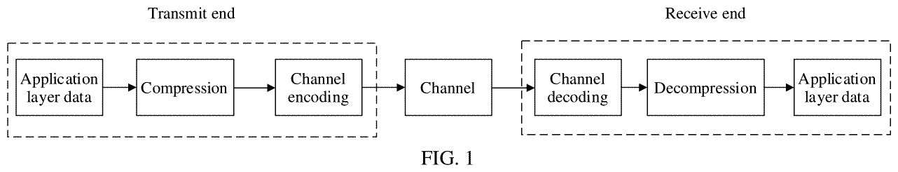

FIG. 1 shows a procedure of a conventional data transmission solution. As shown in FIG. 1, application layer data of a transmit end, for example, a video, a picture, and data, is sent to a receive end through a channel after steps of compression and channel encoding. The receive end performs channel decoding and data decompression on the received data, to obtain the application layer data sent by the transmit end.

Due to a limited bandwidth of a radio channel, video data needs to be efficiently compressed. However, when the video data is efficiently compressed by using video coding technologies such as predictive coding and variable-length coding, a bitstream is very sensitive to a channel bit error. It is well known that the radio channel has various types of noise interference and a high bit error rate. Therefore, it is a quite challenging task to transmit a high-quality video over a wireless mobile network. Coding is one of critical issues. Coding is mainly classified into source coding and channel coding. A main indicator of the source coding is coding efficiency. A main objective of the channel coding is to improve reliability of information transmission. A digital video communication system based on independent source and channel coding requires not only a physical layer adaptation algorithm, but also a video bit rate control module. When a video bit rate does not match a channel capacity, cliff effect similar to that of a physical layer occurs. To be specific, if channel noise is greater than a predicted value, distortion of a reconstructed video is very large; or if channel noise is less than a predicted value, distortion is not reduced.

Therefore, wireless video transmission needs to seamlessly adapt to a channel status. To be specific, the transmit end does not need to change a transmission method based on a channel condition, and quality of a video at the receive end corresponds to a real-time channel condition.

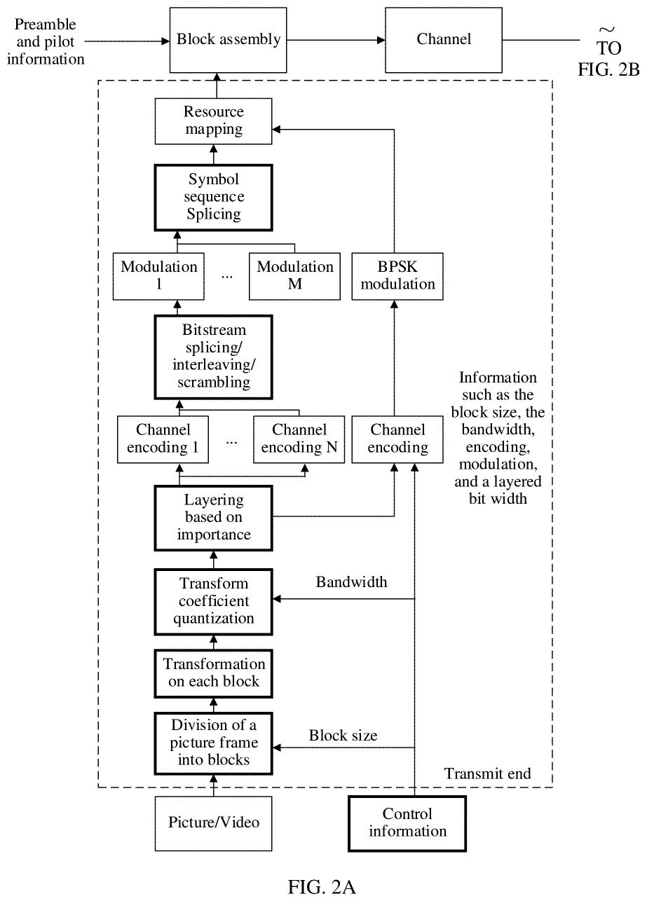

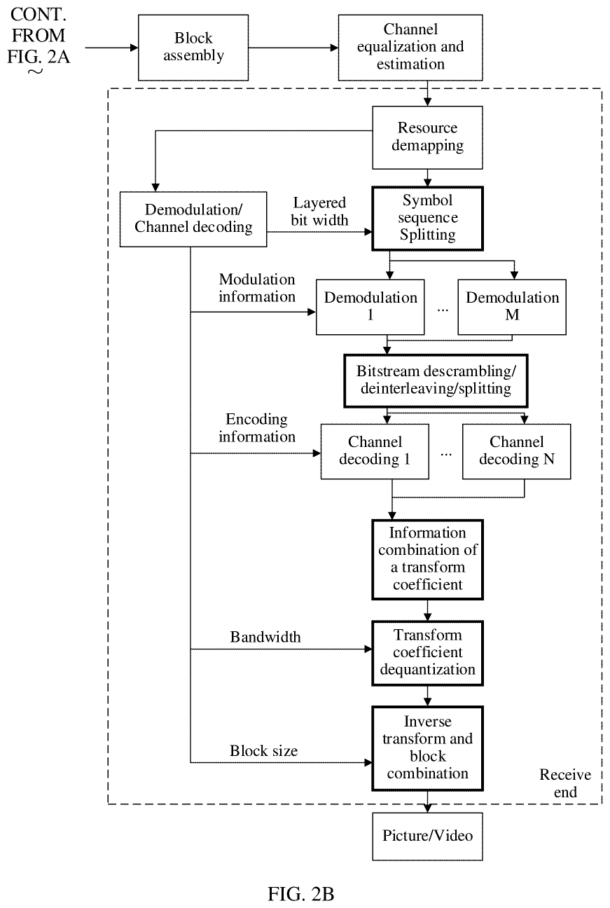

A joint source and channel coding solution adaptive to a channel is proposed, to resolve the foregoing problem. As shown in FIG. 2A and FIG. 2B, a transmit end device divides a picture frame into a picture or a video into blocks, and performs discrete cosine transform (discrete cosine transform, DCT) on each block. Because most energy of the picture is concentrated in a low frequency part obtained after the DCT transform, the picture frame can be compressed through the DCT transform. Then, picture data obtained after the DCT transform is quantized, and is layered based on importance of the data. For layered picture data, rateless encoding is separately performed in different bit planes, for example, channel encoding 1 to channel encoding N shown in FIG. 2A and FIG. 2B. Encoded data is mapped to a resource block through bit splicing and symbol modulation. Control information includes information such as a block size, a bandwidth, encoding, modulation, and a layered bit width in the foregoing process. After separate channel encoding and modulation, the control information is also mapped to a corresponding resource block and sent together with data information.

At the receive end, after performing synchronization, channel estimation, and equalization processing on a received signal, a receive end device performs resource demapping to obtain the control information and the data information. Then, based on the control information, symbol splitting and demodulation are performed on the data information to obtain soft information, and then channel decoding is performed by using a confidence transmission method, to obtain a 0/1 bit probability. Finally, information combination is performed based on the probability to restore original source information. The joint source and channel coding solution shown in FIG. 2A and FIG. 2B can improve quality of wireless video or picture transmission.

### 2. Joint Source and Channel Coding Transmission

The joint source and channel coding transmission may be referred to as layered transmission, user multi-physical layer service data unit (physical layer service data unit, PSDU) transmission, or the like. This is not limited herein. In a possible implementation, data may be divided into a base layer and at least one enhancement layer through the joint source and channel coding transmission.

### 3. Source Layer

A source layer is a PSDU. A user using joint source and channel coding corresponds to a plurality of source layers, that is, the user using the joint source and channel coding corresponds to a plurality of PSDUs. A user not using joint source and channel coding corresponds to one source layer, that is, the user not using the joint source and channel coding corresponds to one PSDU.

### 4. Layer Frequency Domain Resource

The layer frequency domain resource is a frequency domain resource of a source layer. In other words, the layer frequency domain resource is the frequency domain resource allocated to the source layer. The frequency domain resource may be a resource unit (resource unit, RU) or a multi-resource unit (multi-RU, MRU).

### 5. Joint Source and Channel Coding Parameter

The joint source and channel coding parameter may be classified into a joint source and channel coding parameter of one source layer and a joint source and channel coding parameter shared by all source layers.

The joint source and channel coding parameter of one source layer may include at least one of the following: a modulation and coding scheme of the source layer, probability of source distribution of the source layer, and a length of a physical layer service data unit of the source layer. The probability of source distribution is a probability of a binary digit 0 or a probability of a binary digit 1. The length of the physical layer service data unit of the source layer may also be referred to as a number of symbols carried in a data field corresponding to the source layer. The modulation and coding scheme of the source layer is a modulation scheme of the physical layer service data unit of the source layer, and the modulation scheme includes BPSK/QPSK/8-PSK/16QAM/64QAM/256QAM and the like. The length of the physical layer service data unit of the source layer may indicate a mapping relationship between the physical layer service data unit and different bit planes. The mapping relationship may be that one physical layer service data unit corresponds to one bit plane, or one physical layer service data unit corresponds to a plurality of bit planes.

The joint source and channel coding parameter shared by all source layers may include at least one of the following: a frame rate (frame rate), a color coding method (RGB/YUV), a picture size (picture size) (resolution), a pixel depth (pixel depth), a quantization step, a DCT transform or discrete wavelet transform (discrete wavelet transformation, DWT) size (DCT/DWT size), a number of DCT blocks included in each code block, a number of DCT coefficient quantization bit planes, and a number of code blocks. The frame rate is a frame play rate (frame/second), and a supported typical value is 60/90/120. The picture size is a size of a picture: a length (width) and a width (height), and a supported typical value is 1080P (1920*1080)/4K (3840*2160)/2048*1024/4096*2048. The pixel depth is a color depth of each pixel, and a typical value is 8 bits/10 bits. The quantization step is a quantization order. The DCT transform or discrete wavelet transform size is a size of DCT/DWT transform, and a typical value is 4*4/8*8/16*16/32*32. The number of DCT blocks included in each code block is a number of DCT blocks included in a JSCC code block carried in each data field, and a typical value is Oct. 15, 2020/25. The number of DCT coefficient quantization bit planes is a number of bit planes formed by sequentially arranging bits from the most significant bit to the least significant bit after each DCT coefficient is quantized, and a typical value is Aug. 10, 2012. The number of code blocks is a number of picture code blocks carried in each data field.

The foregoing content briefly describes meanings of nouns (communication terms) in embodiments of this application to better understand the technical solutions provided in embodiments of this application, and does not constitute a limitation on the technical solutions provided in embodiments of this application.

For ease of understanding this application, the following describes related technical knowledge in embodiments of this application herein.

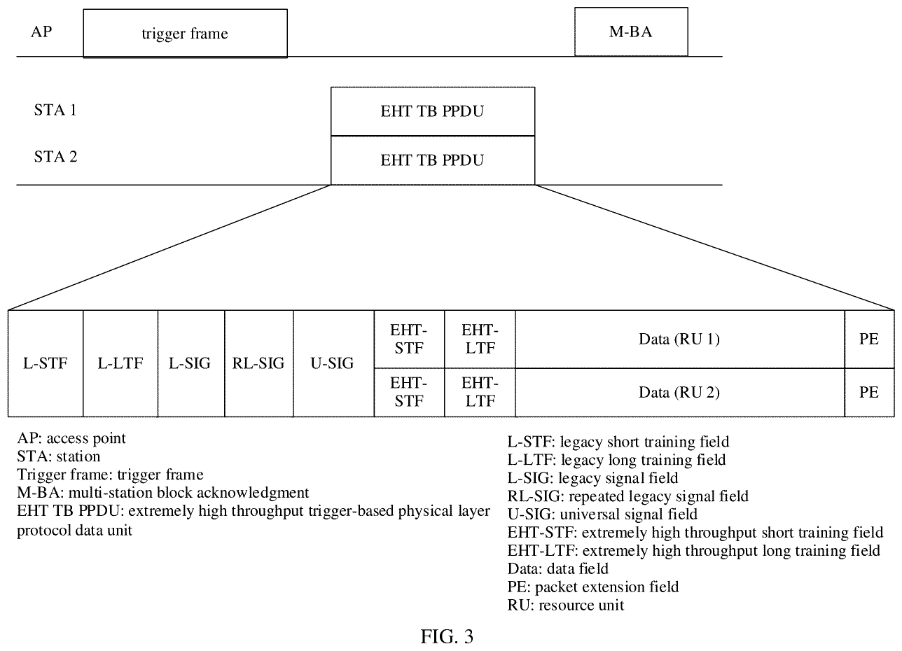

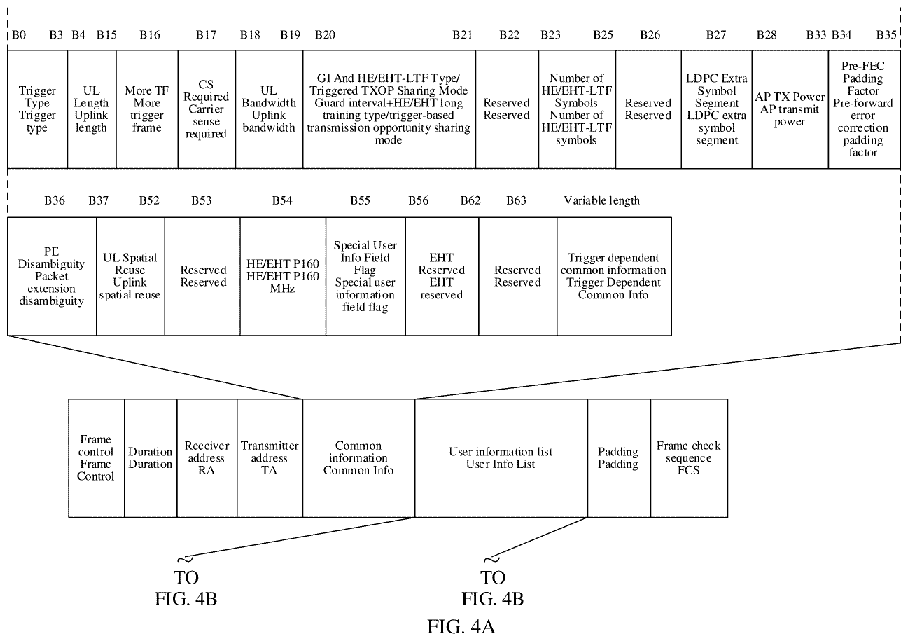

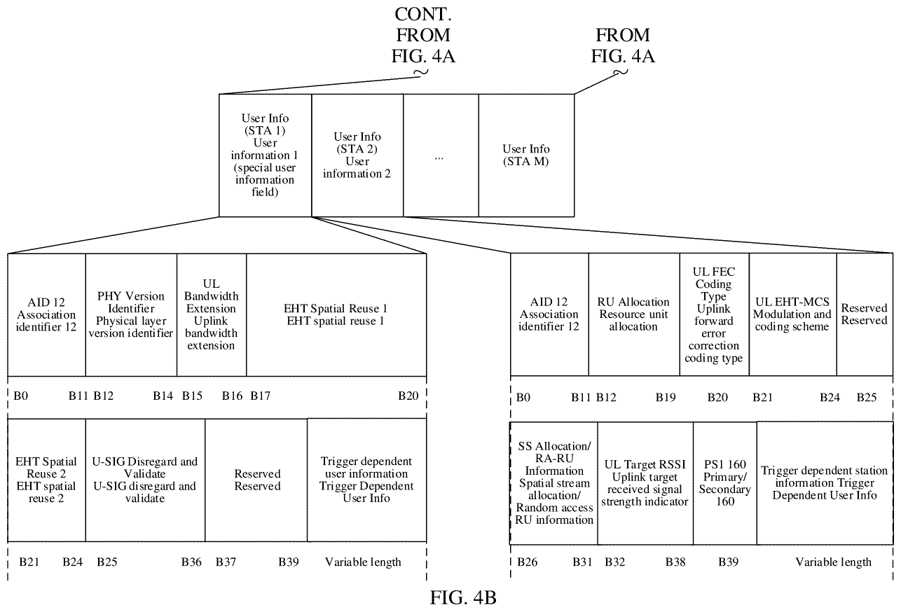

Usually, a station performs uplink data transmission after obtaining transmission permission through channel contention, for example, a channel is preempted in an enhanced distributed channel access (enhanced distributed channel access, EDCA) manner. For example, a trigger-based scheduling uplink transmission method is introduced in 802.11ax, and the trigger-based scheduling uplink transmission method is inherited in 802.11be. The following describes a solution in which an access point triggers uplink multi-user transmission in 802.11be. As shown in FIG. 3, the access point may send a trigger frame. The trigger frame includes resource scheduling and other parameters (such as an association identifier and a modulation and coding scheme) used by one or more users (stations) to send uplink data. For a frame structure of the trigger frame, refer to FIG. 4A and FIG. 4B. As shown in FIG. 4A and FIG. 4B, the trigger frame includes a common information (common info) field and a user information list (user info list) field. The common information field includes common information that needs to be read by all users, and the user information list field includes one or more user information fields, where a first user information field is a special user information field. An association identifier indicates 2007. Some common information is carried after an association identifier field in the special user information field. Although it is a user information field, it carries the common information. Therefore, the first user information field is referred to as the special user information field. Starting from a second user information field, each user information field includes information that needs to be read by each user. In the user information field, an association identifier 12 (association identification 12, AID 12, 12 least significant bits of the AID) indicates an association identifier of a STA, and is generally referred to as an association identifier field for short. A resource unit allocation (RU allocation) subfield and a primary/secondary 160 field are combined to indicate a specific resource unit (resource unit, RU) or multi-resource unit (MRU) allocated to a user corresponding to the AID 12. After receiving the trigger frame, the station may read the common information field and the special user information field. As shown in FIG. 3, a station 1 may receive the trigger frame, and a station 2 may receive the trigger frame. Further, the station may further obtain, through parsing, a user information field that matches an AID of the station, and then send an extremely high throughput trigger-based physical layer protocol data unit (extremely high throughput trigger-based physical layer protocol data unit, EHT TB PPDU) on an RU or MRU indicated by a resource unit allocation subfield in the user information field. For names and functions of fields in the EHT TB PPDU, refer to Table 1. Finally, after receiving an EHT TB PPDU sent by one or more stations, the access point may reply with a multi-station block acknowledgment (Multi-STA block acknowledgment) frame. However, JSCC transmission implemented based on a trigger frame is still in a blank phase.

TABLE 1

| English | | | |
|---|---|---|---|
| acronym/ | Full English | Chinese | |
| abbreviation | expression | expression | Function |
| L-STF | Legacy short | Legacy short | For PPDU discovery, coarse |
| | training field | training field | synchronization, and |
| | | | automatic gain control |
| L-LTF | Legacy long | Legacy long | For precise synchronization |
| | training field | training field | and channel estimation |
| L-SIG | Legacy signal | Legacy signal | For carrying signal |
| | field | field | information related to a |
| | | | PPDU length, to ensure |
| | | | coexistence |
| RL-SIG | Repeated legacy | Repeated legacy | For carrying signal |
| | signal field | signal field | information related to a |
| | | | PPDU length, to ensure |
| | | | coexistence |
| U-SIG | Universal SIG | Universal signal | For carrying related signal |
| | | field | information such as a PPDU |
| | | | bandwidth and a basic service |
| | | | set color |
| EHT-STF | Extremely high | Extremely high | For automatic gain control of |
| | throughput short | throughput short | a subsequent field |
| | training field | training field | |
| EHT-LTF | Extremely high | Extremely high | For channel estimation |
| | throughput long | throughput long | |
| | training field | training field | |
| Data | | Data field | For carrying data information |
| PE | Packet extension | Packet extension | For prolonging processing |
| | | field | time of a receiver |

In view of this, this application provides a communication method, to resolve the foregoing technical problem. The following describes embodiments of this application in detail.

It should be understood that embodiments of this application are applicable to a wireless local area network (wireless local area network, WLAN) scenario, and applicable to an IEEE 802.11 system standard, for example, 802.11ax (Wi-Fi 6), 802.11be (Wi-Fi 7), 802.11bf (SENS, sensing, sensing), or a next-generation standard. Alternatively, embodiments of this application are applicable to a wireless local area network system, for example, an internet of things (internet of things, IoT) network or a vehicle-to-everything (Vehicle to X, V2X) network. Certainly, embodiments of this application are also applicable to another possible communication system, for example, an LTE system, an LTE frequency division duplex (frequency division duplex, FDD) system, an LTE time division duplex (time division duplex, TDD) system, a universal mobile telecommunication system (universal mobile telecommunication system, UMTS), a worldwide interoperability for microwave access (worldwide interoperability for microwave access, WiMAX) communication system, or a future 6G communication system.

The following uses an example in which embodiments of this application are applicable to a WLAN scenario. It should be understood that the WLAN starts from the 802.11a/g standard, and goes through 802.11n, 802.11ac, 802.11ax, and 802.11be that is currently being discussed. 802.11n can also be referred to as high throughput (high throughput, HT), 802.11ac can also be referred to as very high throughput (very high throughput, VHT), 802.11ax can also be referred to as high efficiency (high efficiency, HE) or Wi-Fi 6, and 802.11be can also be referred to as extremely high throughput (extremely high throughput, EHT) or (Wi-Fi 7). Standards before HT, such as 802.11a/b/g, are collectively referred to as non-high throughput (Non-HT).

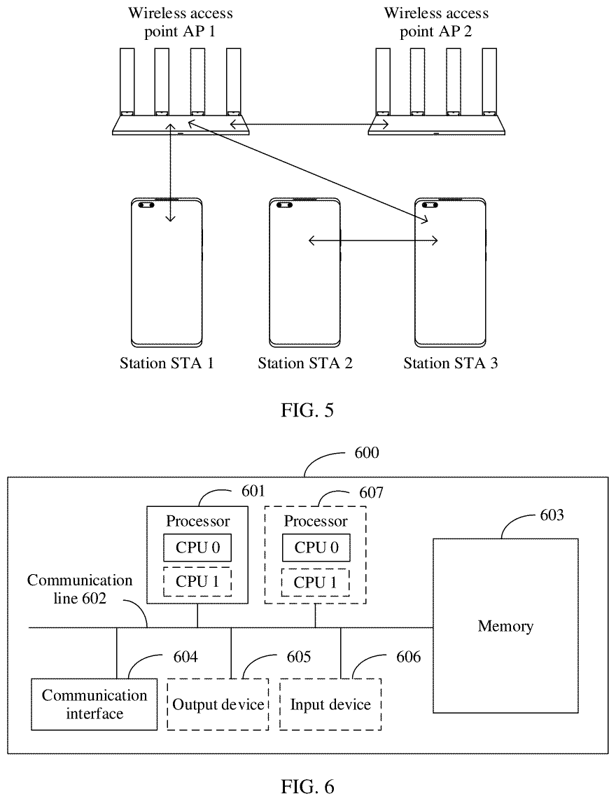

FIG. 5 is a diagram of a network architecture of a WLAN according to an embodiment of this application. In FIG. 5, an example in which the WLAN includes one wireless access point (access point, AP) and two stations (stations, STAs) is used. A STA associated with an AP can receive a radio frame sent by the AP, and can also send a radio frame to the AP. In addition, embodiments of this application are also applicable to communication between APs. For example, the APs may communicate with each other by using a distributed system (distributed system, DS). Embodiments of this application are also applicable to communication between STAs. It should be understood that numbers of APs and STAs in FIG. 5 are merely an example. There may be more or less APs and STAs.

The access point may be an access point used by a terminal device (such as a mobile phone) to access a wired (or wireless) network, and is mainly deployed at home, in a building, and in a campus. A typical coverage radius is tens of meters to hundreds of meters. Certainly, the access point may alternatively be deployed outdoors. The access point is equivalent to a bridge that connects the wired network and the wireless network. The access point is mainly used to connect various wireless network clients together and then connect the wireless network to an ethernet. Specifically, the access point may be a terminal device (for example, a mobile phone) or a network device (for example, a router) with a Wi-Fi chip. The access point may be a device that supports the 802.11be standard. Alternatively, the access point may be a device that supports a plurality of wireless local area network (wireless local area network, WLAN) standards of the 802.11 family such as 802.11ax, 802.11ac, 802.11n, 802.11 g, 802.11b, 802.11a, and a next-generation standard of 802.11be. The access point in this application may be a high efficiency (high efficiency, HE) AP, an extremely high throughput (extremely high throughput, EHT) AP, or an access point applicable to a future-generation Wi-Fi standard.

STAs in embodiments of this application may be various user terminals, user apparatuses, access apparatuses, subscriber stations, subscriber units, mobile stations, user agents, user devices, or other devices, that have a wireless communication function. The user terminal may include various handheld devices, vehicle-mounted devices, wearable devices, computing devices, or other processing devices connected to a wireless modem, that have a wireless communication function; and include various forms of user equipment (user equipment, UE), mobile stations (mobile stations, MSs), terminals (terminals), terminal equipment (terminal equipment), portable communication devices, handheld devices, portable computing devices, entertainment devices, game devices or systems, and global positioning system devices, or any other suitable device configured to perform network communication via a wireless medium. For example, the STA may be a router, a switch, a bridge, or the like. Herein, for ease of description, the devices mentioned above are collectively referred to as a station or a STA.

The AP and the STA in embodiments of this application may be an AP and a STA that are applicable to the IEEE 802.11 system standard. The AP is an apparatus that is deployed in a wireless communication network and that provides a wireless communication function for a STA associated with the AP. The AP may be used as a center of the communication system, and is usually a network-side product that supports MAC and PHY in the 802.11 system standard, for example, may be a communication device such as a base station, a router, a gateway, a repeater, a communication server, a switch, or a bridge. The base station may include a macro base station, a micro base station, a relay station, or the like in various forms. Herein, for ease of description, the devices mentioned above are collectively referred to as an AP. The STA is usually a terminal product that supports media access control (media access control, MAC) and a physical layer (physical, PHY) of the 802.11 system standard, for example, a mobile phone or a notebook computer.

The communication method provided in this application may be applied to a wireless communication system. The wireless communication system may be a wireless local area network (Wireless local area network) or a cellular network. The method may be implemented by a communication device in the wireless communication system or a chip or a processor in the communication device. The communication device may be a wireless communication device that supports concurrent transmission performed on a plurality of links. For example, the communication device is referred to as a multi-link device (Multi-link device) or a multi-band device (multi-band device). Compared with a device that supports only single-link transmission, the multi-link device has higher transmission efficiency and a higher throughput. The multi-link device includes one or more affiliated stations STAs (affiliated STAs). The affiliated STA is a logical station and may operate on one link. The affiliated station may be an access point (Access Point, AP) or a non-access point station (non-Access Point Station, non-AP STA). For ease of description, in this application, a multi-link device whose affiliated station is an AP may be referred to as a multi-link AP, a multi-link AP device, or an AP multi-link device (AP multi-link device). A multi-link device whose affiliated station is a non-AP STA may be referred to as a multi-link STA, a multi-link STA device, or a STA multi-link device (STA multi-link device).

In addition, the technical solutions provided in embodiments of this application are applicable to a plurality of system architectures. A network architecture and a service scenario that are described in embodiments of this application are intended to describe the technical solutions in embodiments of this application more clearly, and do not constitute a limitation on the technical solutions provided in embodiments of this application. A person of ordinary skill in the art may know that with evolution of the network architecture and emergence of new service scenarios, the technical solutions provided in embodiments of this application are also applicable to a similar technical problem.

Optionally, the wireless access point, the station, and the like in FIG. 5 may be implemented by one device, may be jointly implemented by a plurality of devices, or may be a functional module in one device. This is not specifically limited in embodiments of this application. It may be understood that the foregoing function may be a network element in a hardware device, a software function running on dedicated hardware, or a virtualization function instantiated on a platform (for example, a cloud platform).

For example, each device in FIG. 5 may be implemented by a communication apparatus 600 in FIG. 6. FIG. 6 is a diagram of a hardware structure applicable to a communication apparatus according to an embodiment of this application. The communication apparatus 600 includes at least one processor 601, a communication line 602, a memory 603, and at least one communication interface 604.

The processor 601 may be a general-purpose central processing unit (central processing unit, CPU), a microprocessor, an application-specific integrated circuit (application-specific integrated circuit, ASIC), or one or more integrated circuits configured to control program execution in solutions of this application.

The communication line 602 may include a path for transmitting information between the foregoing components.

The communication interface 604 is any apparatus (such as an antenna) like a transceiver, and is configured to communicate with another device or a communication network, for example, an ethernet, a RAN, or a wireless local area network (wireless local area network, WLAN).

The memory 603 may be a read-only memory (read-only memory, ROM) or another type of static storage device that can store static information and instructions, or a random access memory (random access memory, RAM) or another type of dynamic storage device that can store information and instructions, or may be an electrically erasable programmable read-only memory (electrically erasable programmable read-only memory, EEPROM), a compact disc read-only memory (compact disc read-only memory, CD-ROM) or another compact disc storage, an optical disc storage (including a compact disc, a laser disc, an optical disc, a digital versatile disc, a Blu-ray disc, or the like), a magnetic disk storage medium or another magnetic storage device, or any other medium that can be accessed by a computer and that can be configured to carry or store expected program code in an instruction form or in a data structure form, but is not limited thereto. The memory may exist independently, and may be connected to the processor through the communication line 602. The memory may alternatively be integrated with the processor. The memory provided in embodiments of this application may be usually non-volatile. The memory 603 is configured to store computer-executable instructions for performing the solutions in this application, and the processor 601 controls execution. The processor 601 is configured to execute the computer-executable instructions stored in the memory 603, to implement the method provided in the following embodiments of this application.

Optionally, the computer-executable instructions in embodiments of this application may also be referred to as application program code. This is not specifically limited in embodiments of this application.

In a possible implementation, the processor 601 may include one or more CPUs, for example, a CPU 0 and a CPU 1 in FIG. 6.

In a possible implementation, the communication apparatus 600 may include a plurality of processors, for example, the processor 601 and a processor 607 in FIG. 6. Each of these processors may be a single-core (single-CPU) processor, or may be a multi-core (multi-CPU) processor. The processor herein may be one or more devices, circuits, and/or processing cores configured to process data (for example, computer program instructions).

In a possible implementation, the communication apparatus 600 may further include an output device 605 and an input device 606. The output device 605 communicates with the processor 601, and may display information in a plurality of manners. For example, the output device 605 may be a liquid crystal display (liquid crystal display, LCD), a light-emitting diode (light emitting diode, LED) display device, a cathode ray tube (cathode ray tube, CRT) display device, or a projector (projector). The input device 606 communicates with the processor 601, and may receive an input of a user in a plurality of manners. For example, the input device 606 may be a mouse, a keyboard, a touchscreen device, a sensor device, or the like.

The communication apparatus 600 may be a general-purpose device or a dedicated device. During specific implementation, the communication apparatus 600 may be a portable computer, a network server, a personal digital assistant (personal digital assistant, PDA), a mobile phone, a tablet computer, a wireless terminal device, an embedded device, or a device having a structure similar to that in FIG. 6. A type of the communication apparatus 600 is not limited in embodiments of this application.

After the communication apparatus is powered on, the processor 601 may read the software program in the memory 603, interpret and execute instructions of the software program, and process data of the software program. When data needs to be sent wirelessly, the processor 601 performs baseband processing on the to-be-sent data, and then outputs a baseband signal to the radio frequency circuit. The radio frequency circuit performs radio frequency processing on the baseband signal, and then sends a radio frequency signal in a form of an electromagnetic wave through the antenna. When data is sent to the communication apparatus, the radio frequency circuit receives the radio frequency signal through the antenna, converts the radio frequency signal into a baseband signal, and outputs the baseband signal to the processor 601. The processor 601 converts the baseband signal into data and processes the data.

In another implementation, the radio frequency circuit and the antenna may be disposed independently of the processor for baseband processing. For example, in a distributed scenario, the radio frequency circuit and the antenna may be disposed remotely and independently of the communication apparatus.

The following describes the technical solutions provided in embodiments of this application with reference to the accompanying drawings. It may be understood that the first device may be the AP or the STA in FIG. 5, the second device may be the AP or the STA in FIG. 5, and a third device may be the AP or the STA in FIG. 5. This is not limited herein. The following describes the technical solutions provided in embodiments of this application by using an example in which the first device is an AP, and the second device and the third device are STAs.

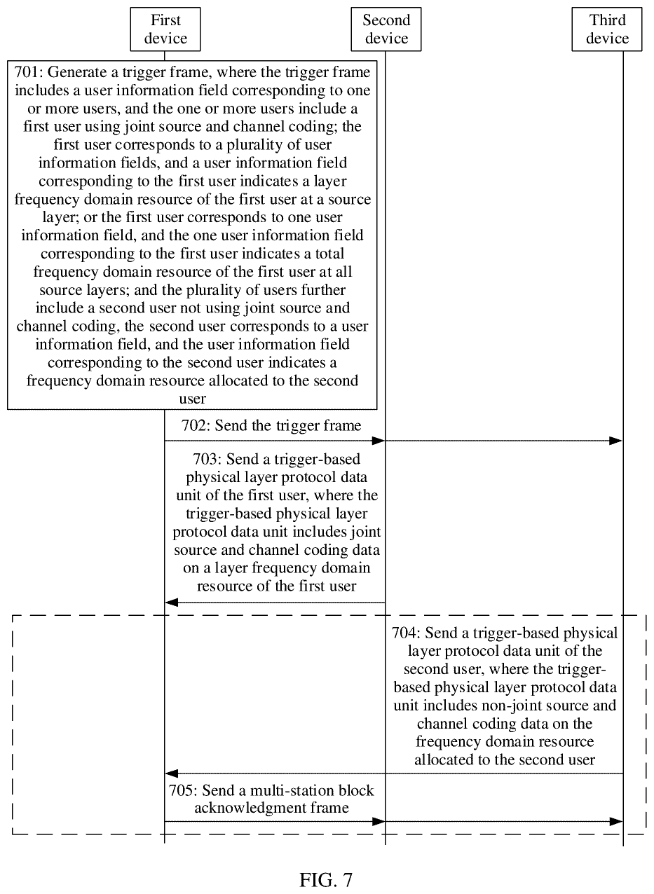

FIG. 7 is a schematic flowchart in which one or more users perform trigger-based JSCC transmission according to an embodiment of this application. As shown in FIG. 7, the method includes but is not limited to the following steps.

701: A first device generates a trigger frame, where the trigger frame includes a user information field corresponding to the one or more users, and the one or more users include a first user using joint source and channel coding. The first user corresponds to a plurality of user information fields, and a user information field corresponding to the first user indicates a layer frequency domain resource of the first user at a source layer. Alternatively, the first user corresponds to one user information field, and the one user information field corresponding to the first user indicates a total frequency domain resource of the first user at all source layers. The plurality of users further include a second user not using the joint source and channel coding, the second user corresponds to a user information field, and the user information field corresponding to the second user indicates a frequency domain resource allocated to the second user.

In a possible implementation, the trigger frame may include a user information field corresponding to one user, and the one user is the first user. In another possible implementation, the trigger frame may include a user information field corresponding to a plurality of users, and the plurality of users include the first user and the second user. There may be one or more first users, and there may also be one or more second users. This is not limited herein. It should be understood that one first user may correspond to one or more user information fields, and one second user corresponds to one user information field.

Optionally, a user information field corresponding to the first user includes a resource unit allocation field and a primary/secondary 160 field. In a possible implementation, that the user information field corresponding to the first user indicates the layer frequency domain resource of the first user at the source layer may be understood as that the resource unit allocation field and the primary/secondary 160 field jointly indicate the layer frequency domain resource of the first user at the source layer. In other words, for the first user, when allocating resources, the first device may consider different source layers as data corresponding to different user information fields, and allocate a corresponding RU or MRU to data of each source layer. In another possible implementation, that the user information field corresponding to the first user indicates the total frequency domain resource of the first user at all the source layers may be understood as that the resource unit allocation field and the primary/secondary 160 field jointly indicate the total frequency domain resource of the first user at all the source layers.

Optionally, a user information field corresponding to the second user may include a resource unit allocation field and a primary/secondary 160 field, and the resource unit allocation field and the primary/secondary 160 field jointly indicate a frequency domain resource allocated to the second user. The frequency domain resource allocated to the second user may be understood as a layer frequency domain resource allocated to the second user at a source layer, or a total frequency domain resource allocated to the second user at all source layers. Because the second user corresponds to only one source layer, a size of a layer frequency domain resource allocated to the second user at the one source layer is the same as a size of a total frequency domain resource allocated to the second user at all source layers. In other words, for the second user, when allocating resources, the first device may consider one source layer as data corresponding to one user information field, and allocate a corresponding RU or MRU to data of the one source layer.

Optionally, the trigger frame indicates that there is a user using joint source and channel coding in one or more users. Specifically, that there is the user using joint source and channel coding in the one or more users may be indicated in any one of the following manners.

Manner 1.1: The trigger frame further includes a common information field, and the common information field indicates that there is the user using joint source and channel coding in the one or more users. For example, some or all bits of reserved fields such as B55 to B62 and B63 in the common information field indicate that there is the user using joint source and channel coding in one or more users. When the reserved field indicates that there is the user using joint source and channel coding in the one or more users, a name of the reserved field may be changed, and a specific name is not limited. For example, if values of the reserved fields such as B55 to B62 and B63 in the common information field are 0, it indicates that there is a user using joint source and channel coding in one or more users; or if values of the reserved fields such as B55 to B62 and B63 in the common information field are 1, it indicates that there is no user using joint source and channel coding in one or more users. Alternatively, if values of the reserved fields such as B55 to B62 and B63 in the common information field are 1, it indicates that there is a user using joint source and channel coding in one or more users; or if values of the reserved fields such as B55 to B62 and B63 in the common information field are 0, it indicates that there is no user using joint source and channel coding in one or more users.

Manner 1.2: The trigger frame further includes a special user information field, and the special user information field indicates that there is the user using joint source and channel coding in the one or more users. For example, a reserved bit in the special user information field indicates that there is a user using joint source and channel coding in one or more users, that is, some or all bits of B37 to B39 in the special user information field indicates that there is a user using joint source and channel coding in one or more users. For example, if values of some or all bits of B37 to B39 in the special user information field are 0, it indicates that there is a user using joint source and channel coding in one or more users; or if values of some or all bits of B37 to B39 in the special user information field are 1, it indicates that there is no user using joint source and channel coding in one or more users. Alternatively, if values of some or all bits of B37 to B39 in the special user information field are 1, it indicates that there is a user using joint source and channel coding in one or more users; or if values of some or all bits of B37 to B39 in the special user information field are 0, it indicates that there is no user using joint source and channel coding in one or more users. It should be understood that the special user information field may be considered as an extension of the common information field. Like the common information field, the special user information field may also be read by all users that receive the trigger frame, to learn whether there is a user using joint source and channel coding in one or more users.

The special user information field is a first user information field in the trigger frame, and an association identifier field included in the user information field indicates 2007.

Optionally, that there is the user using joint source and channel coding in the one or more users may be indicated by another bit or field newly added for a next-generation standard. This is not limited herein.

It can be learned that, for a manner 2.1 and a manner 2.2, because the common information field or the special user information field is a field that can be read by all users, all users that receive the trigger frame can learn that there is a user using joint source and channel coding.

In addition, whether a user corresponding to another user information field uses joint source and channel coding may be learned by using the another user information field, where the another user information field is a user information field other than the special user information field in the trigger frame. Specifically, whether the user corresponding to the another user information field uses joint source and channel coding may be indicated in any one of the following manners.

Manner 2.1: A user information field corresponding to the first user further indicates that the first user uses joint source and channel coding transmission. In a possible implementation, a user information field corresponding to the first user may further include a modulation and coding scheme field, and the modulation and coding scheme field indicates that the first user uses joint source and channel coding transmission. For example, when the modulation and coding scheme field indicates a special modulation and coding scheme, the modulation and coding scheme field indicates that the first user uses joint source and channel coding transmission. In another possible implementation, B25 in one user information field corresponding to the first user indicates that the first user uses joint source and channel coding transmission, and a reserved field is in B25. In addition, the manner 2.1 is applicable to a scenario in which the first user corresponds to one or more user information fields. When the first user corresponds to a plurality of user information fields, one or more user information fields in the plurality of user information fields corresponding to the first user may indicate that the first user uses joint source and channel coding transmission.

Manner 2.2: The first user corresponds to a plurality of user information fields, and that the first user uses joint source and channel coding transmission is indicated by the plurality of user information fields corresponding to the first user that use a same association identifier field. A user information field corresponding to the first user corresponds to scheduling information of data of a source layer of the first user. If the plurality of user information fields include the same association identifier field, it implicitly indicates that the user uses joint source and channel coding transmission.

Manner 2.3: The first user corresponds to the plurality of user information fields, a number of source layers of the first user is equal to a number of user information fields that use the same association identifier field, and the association identifier field indicates an association identifier of the first user. That the first user uses joint source and channel coding transmission is indicated by the number of source layers of the first user.

Manner 2.4: The first user corresponds to one user information field, and the one user information field corresponding to the first user further indicates at least one of the following: a number of source layers of the first user and a layer frequency domain resource of the first user at each source layer. For example, the one user information field corresponding to the first user further includes a number of layers field, and the number of layers field indicates at least one of the following: a number of source layers of the first user and a layer frequency domain resource of the first user at each source layer. That the first user uses joint source and channel coding transmission is indicated by the number of source layers of the first user. For example, if the number of source layers of the user is 1, it indicates that the user does not use joint source and channel coding transmission, and if the number of source layers of the user is greater than 1, it indicates that the user uses joint source and channel coding transmission. For a method in which the number of layers field indicates the number of source layers of the first user and/or the layer frequency domain resource of the first user at each source layer, refer to the following method in which a layer resource assignment field in a trigger-based physical layer protocol data unit indicates the number of source layers of the first user and/or the layer frequency domain resource of the first user at each source layer. Details are not described herein again.

It should be noted that, in a possible implementation, any one or more of the manner 1.1 and the manner 1.2 may be used together with any one of the manner 2.1 to the manner 2.4. For example, the common information field indicates that there is a user performing JSCC transmission, and further specifically indicates a user that performs JSCC transmission. Based on an indication in common information field, a user that does not use JSCC transmission may also learn that there is JSCC transmission. In some embodiments, a method for transmitting a TB PPDU by a non-JSCC user is also affected.

Optionally, a modulation and coding scheme of a source layer may be selected by a triggering user, or may be notified by the first device. For details, refer to the following manners.

Manner 3.1: A user information field corresponding to the first user indicates a modulation and coding scheme of the first user at a source layer. That is, the modulation and coding scheme of the first user at the source layer is notified by the first device. In a possible implementation, the user information field corresponding to the first user may further include a modulation and coding scheme field, and the modulation and coding scheme field indicates the modulation and coding scheme of the first user at the source layer.

Manner 3.2: A user information field corresponding to the first user indicates the first user to select a modulation and coding scheme of a source layer. That is, after the trigger frame is received, the modulation and coding scheme of the source layer may be selected. In a possible implementation, the user information field corresponding to the first user may further include a modulation and coding scheme field, and the modulation and coding scheme field indicates the first user to select the modulation and coding scheme of the source layer. For example, when the modulation and coding scheme field indicates a special modulation and coding scheme, the modulation and coding scheme field indicates the first user to select the modulation and coding scheme of the source layer.

The source layers in the manner 3.1 and the manner 3.2 may be basic layers or enhancement layers of the first user. This is not limited herein.

It should be noted that optionally, when the first user corresponds to a plurality of user information fields, information indicated by modulation and coding scheme fields included in different user information fields may use any one of the following manners. The plurality of user information fields corresponding to the first user may include a first user information field and a second user information field, the first user information field includes a first modulation and coding scheme field, and the second user information field includes a second modulation and coding scheme field.

Manner 4.1: The first modulation and coding scheme field indicates a modulation and coding scheme of a base layer of the first user, and the second modulation and coding scheme field indicates the first user to select a modulation and coding scheme of a source layer corresponding to the second user information field. The source layer corresponding to the second user information field may be an enhancement layer. That is, the first device indicates the modulation and coding scheme of the base layer only by using the first modulation and coding scheme field, and a modulation and coding scheme field corresponding to another enhancement layer indicates a special value, so that the first user can select the modulation and coding scheme. In addition, the second modulation and coding scheme field further indicates that the first user uses joint source and channel coding transmission.

Manner 4.2: The first modulation and coding scheme field indicates a modulation and coding scheme of a source layer corresponding to the first user information field, and the second modulation and coding scheme field indicates a modulation and coding scheme of a source layer corresponding to the second user information field.

Manner 4.3: The first modulation and coding scheme field indicates the first user to select a modulation and coding scheme of a source layer corresponding to the first user information field, and the second modulation and coding scheme field indicates the first user to select a modulation and coding scheme of a source layer corresponding to the second user information field. In a possible implementation, the first modulation and coding scheme field and the second modulation and coding scheme field further indicate that the first user uses joint source and channel coding transmission.

In the manner 4.2 and the manner 4.3, the source layer corresponding to the first user information field is different from the source layer corresponding to the second user information field. For example, the source layer corresponding to the first user information field may be a base layer, and the source layer corresponding to the second user information field may be an enhancement layer. Alternatively, the source layer corresponding to the first user information field may be an enhancement layer, and the source layer corresponding to the second user information field may be a base layer. Alternatively, the source layer corresponding to the first user information field may be an enhancement layer, and the source layer corresponding to the second user information field may be another enhancement layer.

Optionally, for another user information field except the first user information field and the second user information field in the plurality of user information fields corresponding to the first user, in the manner 4.1, for information indicated by a modulation and coding scheme field included in the another user information field, refer to information indicated by the second modulation and coding scheme field in the manner 4.1; in the manner 4.2, for information indicated by a modulation and coding scheme field included in the another user information field, refer to information indicated by the second modulation and coding scheme field in the manner 4.1 or the manner 4.3; and in the manner 4.3, for information indicated by a modulation and coding scheme field included in the another user information field, refer to information indicated by the first modulation and coding scheme field in the manner 4.2 or the manner 4.3. It should be understood that, when the trigger frame indicates the first user to select modulation and coding schemes of all source layers, a trigger-based physical layer protocol data unit of the first user further indicates modulation and coding schemes of the first user at all the source layers. For example, the trigger-based physical layer protocol data unit includes first signal fields on different layer frequency domain resources of the first user, and the modulation and coding schemes of the first user at all the source layers are indicated by the first signal fields on the different layer frequency domain resources of the first user.

It should be noted that, when the first user corresponds to the one user information field, the one user information field corresponding to the first user includes a modulation and coding scheme field, and information indicated by the modulation and coding scheme field may use any one of the following manners.

Manner 5.1: The modulation and coding scheme field indicates that the first user uses joint source and channel coding transmission, that is, the modulation and coding scheme field indicates a special value. It should be understood that, when the modulation and coding scheme field indicates that the first user uses joint source and channel coding transmission, modulation and coding schemes of the first user at all source layers are determined by the user, that is, a trigger-based physical layer protocol data unit of the first user further indicates the modulation and coding schemes of the first user at all the source layers. For example, the trigger-based physical layer protocol data unit includes first signal fields on different layer frequency domain resources of the first user, and the modulation and coding schemes of the first user at all the source layers are indicated by the first signal fields on the different layer frequency domain resources of the first user. For another example, the trigger-based physical layer protocol data unit includes a first signal field on a total frequency domain resource of the first user at all source layers, and the first signal field indicates the modulation and coding schemes of the first user at all the source layers. For another example, the trigger-based physical layer protocol data unit includes a first signal field of the first user, the first signal field includes signal B fields on different layer frequency domain resources of the first user, and the modulation and coding schemes of the first user at all the source layers are indicated by the signal B fields on the different layer frequency domain resources of the first user.

Manner 5.2: The modulation and coding scheme field indicates a modulation and coding scheme of a base layer of the first user. In a possible implementation, a modulation and coding scheme of an enhancement layer of the first user is determined by the user, that is, the trigger-based physical layer protocol data unit of the first user further indicates the modulation and coding scheme of the first user at the enhancement layer. For example, the trigger-based physical layer protocol data unit includes a first signal field on a layer frequency domain resource at the enhancement layer, and the modulation and coding schemes of the first user at all the source layers are indicated by the first signal field on the layer frequency domain resource at the enhancement layer. For another example, the trigger-based physical layer protocol data unit includes a first signal field on a total frequency domain resource of the first user at all source layers, and the first signal field indicates the modulation and coding scheme of the first user at the enhancement layer. For another example, the trigger-based physical layer protocol data unit includes a first signal field of the first user, the first signal field includes a signal B field on a layer frequency domain resource at the enhancement layer, and the modulation and coding scheme of the first user at the enhancement layer is indicated by the signal B field on the layer frequency domain resource at the enhancement layer. In another possible implementation, the modulation and coding scheme of the enhancement layer of the first user is a predefined modulation and coding scheme. For example, an MCS of an enhancement layer is based on an MCS of a base layer, and corresponding MCSs value increase one by one. For example, there are three layers in total. A base layer uses an MCS 5, an enhancement layer 1 uses an MCS 7, and an enhancement layer 2 uses an MCS 9.

It can be learned that in either the manner 5.1 or the manner 5.2, the trigger frame does not need to indicate modulation and coding schemes of all source layers. This reduces overheads.

Optionally, the user information field corresponding to the second user may also include a modulation and coding scheme field, and the modulation and coding scheme field indicates a modulation and coding scheme of the second user.

Optionally, when one user information field corresponding to the first user indicates a total frequency domain resource of the first user at all source layers, a layer frequency domain resource of the first user at each source layer may be indicated in the trigger frame, as described in the manner 2.4, or a layer frequency domain resource of the first user at each source layer may be a predefined frequency domain resource. For that the layer frequency domain resource of the first user at each source layer is the predefined frequency domain resource, refer to the following manner 8.2. Because the layer frequency domain resource of the user at each source layer is the predefined frequency domain resource, no additional indication is required in the trigger frame. This reduces overheads.

After step 701, step 702 and step 703 may be further performed.

702: The first device sends the trigger frame.

Correspondingly, the second device receives the trigger frame, and the third device receives the trigger frame.

703: The second device sends the trigger-based physical layer protocol data unit of the first user, where the trigger-based physical layer protocol data unit includes joint source and channel coding data on a layer frequency domain resource of the first user.

Correspondingly, the first device receives the trigger-based physical layer protocol data unit of the first user.

That the trigger-based physical layer protocol data unit includes the joint source and channel coding data on the layer frequency domain resource of the first user may be understood as follows: The trigger-based physical layer protocol data unit includes a data field on each layer frequency domain resource of the first user, and one data field includes joint source and channel coding data of one source layer of the first user.

Optionally, when the first user corresponds to the plurality of user information fields, the trigger-based physical layer protocol data unit of the first user may be implemented in any one of the following manners.

Manner 6.1: The trigger-based physical layer protocol data unit includes a first signal field of the first user, the first signal field of the first user indicates at least one of the following: a joint source and channel coding parameter of one source layer corresponding to the first user, and a joint source and channel coding parameter shared by all the source layers of the first user, and the first signal field of the first user is on a layer frequency domain resource at the one source layer corresponding to the first user. It should be understood that the number of source layers of the first user is the same as a number of first signal fields of the first user.

Manner 6.2: The trigger-based physical layer protocol data unit includes a data field of the first user, the data field of the first user indicates at least one of the following: a joint source and channel coding parameter of one source layer corresponding to the first user, and a joint source and channel coding parameter shared by all the source layers of the first user, and the data field of the first user is on a layer frequency domain resource at the one source layer corresponding to the first user. That is, a frame header or a frame body of a media access control (media access control, MAC) frame in the data field of the first user includes at least one of the following: the joint source and channel coding parameter of the one source layer corresponding to the first user, and the joint source and channel coding parameter shared by all the source layers of the first user. It should be understood that the number of source layers of the first user is the same as a number of data fields of the first user. In addition, in the manner 6.2, the trigger frame needs to indicate modulation and coding schemes of the first user at all the source layers. For example, an AP indicates MCSs of all layers. For example, modulation and coding schemes of the first user at all the source layers are indicated by the plurality of user information fields corresponding to the first user.

The joint source and channel coding parameter of the one source layer corresponding to the first user includes at least one of the following: a modulation and coding scheme of the one source layer corresponding to the first user, and probability of source distribution of the one source layer corresponding to the first user. The joint source and channel coding parameter shared by all the source layers of the first user may include at least one of the following: a frame rate, a color coding method, a picture size, a pixel depth, a quantization step, a DCT transform or discrete wavelet transform size, a number of DCT blocks included in each code block, a number of DCT coefficient quantization bit planes, and a number of code blocks.

It can be learned that in the manner 6.1 and the manner 6.2, when the user using JSCC transmission corresponds to the plurality of user information fields, the trigger-based physical layer protocol data unit may include a first signal field or data field at one source layer of the user, so that a user that receives the trigger-based physical layer protocol data unit can learn of, by reading the first signal field or data field of the user, a joint source and channel coding parameter required for reading joint source and channel coding data of the user at the source layer.

Optionally, when the first user corresponds to the one user information field, the trigger-based physical layer protocol data unit of the first user may be implemented in any one of the following manners.

Manner 7.1: The trigger-based physical layer protocol data unit includes a first signal field of the first user, the first signal field of the first user indicates at least one of the following: a joint source and channel coding parameter of one source layer corresponding to the first user, and a joint source and channel coding parameter shared by all the source layers of the first user, and the first signal field of the first user is on a layer frequency domain resource at the one source layer corresponding to the first user.

Manner 7.2: The trigger-based physical layer protocol data unit includes a first signal field of the first user, the first signal field of the first user indicates at least one of the following: a joint source and channel coding parameter of each source layer of the first user, and a joint source and channel coding parameter shared by all the source layers of the first user, and the first signal field of the first user is on the total frequency domain resource of the first user at all the source layers.

Manner 7.3: The trigger-based physical layer protocol data unit includes a first signal field of the first user, the first signal field of the first user includes a signal A field and at least one signal B field, the signal A field is on the total frequency domain resource of the first user at all the source layers, one signal B field is on a layer frequency domain resource of one source layer corresponding to the first user, the signal A field indicates a joint source and channel coding parameter shared by all the source layers of the first user, and the one signal B field indicates a joint source and channel coding parameter of the one source layer corresponding to the first user. It can be learned that when the user using JSCC transmission corresponds to one user information field, the trigger-based physical layer protocol data unit may include a first signal field of the user, and the first signal field of the user includes a signal A field and at least one signal B field. Because the signal A field is on the total frequency domain resource of the user at all the source layers, parameters indicated by the signal A field are common parameters corresponding to different source layers. The signal B field is on the layer frequency domain resource at the source layer corresponding to the user, that is, a parameter indicated by the signal B field is a private parameter corresponding to the source layer, so that a user that receives the trigger-based physical layer protocol data unit can separately read a parameter required for parsing each source layer of the user, thereby reducing complexity of reading the signal field.

It can be learned that in the manner 7.1 and the manner 7.2, when the user using JSCC transmission corresponds to the one user information field, the trigger-based physical layer protocol data unit may include a first signal field at one source layer or all source layers of the user, so that the user that receives the trigger-based physical layer protocol data unit can learn of, by reading the first signal field of the user, a joint source and channel coding parameter required for reading joint source and channel coding data of the user at the source layer.

Optionally, in any one of the manner 6.1 and the manner 7.1 to the manner 7.3, the first signal field of the first user further indicates at least one of the following: a number of all source layers of the first user and an identifier of a source layer corresponding to the first user. In any one of the manner 6.1, the manner 7.1, to the manner 7.3, the identifier of the source layer corresponding to the first user may be understood as an identifier of one source layer corresponding to the first user. In the manner 7.3, the signal A field may indicate a number of all source layers of the first user, and one signal B field may indicate an identifier of a source layer corresponding to the first user, that is, the one signal B field may indicate an identifier of one source layer corresponding to the first user. In the manner 7.2, the identifier of the source layer corresponding to the first user may be understood as an identifier of each source layer in all the source layers of the first user. It can be learned that, the user that receives the trigger-based physical layer protocol data unit may further learn of at least one of the following: a number of all source layers of the user using JSCC transmission, and an identifier of a source layer corresponding to the user.

Optionally, in any one of the manner 7.1 to the manner 7.3, the layer frequency domain resource of the first user at each source layer may be indicated by a second signal field of the first user or predefined in a protocol. Specifically, this may be implemented in any one of the following manners. This is not limited herein.

Manner 8.1: The first signal field of the first user further includes a layer resource assignment field, and the layer resource assignment field indicates at least one of the following: the number of source layers of the first user and the layer frequency domain resource of the first user at each source layer. In the manner 7.3, that the first signal field of the first user further includes the layer resource assignment field may be understood as that the signal A field further includes the layer resource assignment field. It can be learned that the user that receives the trigger-based physical layer protocol data unit may further learn of, by using the first signal field of the user using JSCC transmission, at least one of the following: the number of source layers of the user and the layer frequency domain resource of the user at each source layer.

Manner 8.2: The layer frequency domain resource of the first user at each source layer is the predefined frequency domain resource. It can be learned that because the layer frequency domain resource of the user at each source layer is the predefined frequency domain resource, no additional indication is required in the trigger-based physical layer protocol data unit. This reduces overheads. In addition, the user that receives the trigger-based physical layer protocol data unit may perform decoding based on a fixed frequency domain resource size.

For the manner 8.1, in a possible implementation, a value of the layer resource assignment field indicates at least one of the following: the number of source layers of the first user and the layer frequency domain resource of the first user at each source layer.

For example, in a second row of Table 2, RU242-RU242 indicates that the number of source layers of the first user is 2, and sizes of layer frequency domain resources of the first user at the two source layers are both RU242. To be specific, when the value of the layer resource assignment field is 0, it indicates that the number of source layers of the first user is 2, and the sizes of the layer frequency domain resources of the first user at the two source layers are both RU242. In a third row of Table 2, RU242-RU242-RU242 indicates that the number of source layers of the first user is 3, and sizes of layer frequency domain resources of the first user at the three source layers are all RU242. To be specific, when the value of the layer resource assignment field is 1, it indicates that the number of source layers of the first user is 3, and the sizes of the layer frequency domain resources of the first user at the three source layers are all RU242. In a fifth row of Table 2, RU484-RU242 indicates that the number of source layers of the first user is 2, a size of a layer frequency domain resource of the first user at one source layer is RU484, and a size of a layer frequency domain resource of the first user at the other source layer is RU242. To be specific, when the value of the layer resource assignment field is 3, it indicates that the number of source layers of the first user is 2, the size of the layer frequency domain resource of the first user at the one source layer is RU484, and the size of the layer frequency domain resource of the first user at the other source layer is RU242. Other values of the layer resource assignment field in Table 2 are similar, and details are not described herein again. It should be understood that, in this application, RUs or MRUs of different sizes are RUs or MRUs predefined in a standard, including sizes and locations. For example, a 2*2*996+484-tone MRU includes two 996-tone RUs and one 484-tone RU that are predefined in the standard.

TABLE 2

| Value of the | Number of source layers of the first user |
|---|---|
| layer resource | and the layer frequency domain resource |
| assignment field | of the first user at each source layer |
| 0 | RU242-RU242 (a size of a total frequency domain resource of the |
| | first user at both source layers is RU484) |
| 1 | RU242-RU242-RU242 (a size of a total frequency domain resource |
| | of the first user at all source layers is RU484 + RU242) |
| 2 | RU242-RU242-RU242-RU242 (a size of a total frequency domain |
| | resource of the first user at all source layers is RU996) |
| 3 | RU484-RU242 (a size of a total frequency domain resource of the |
| | first user at both source layers is RU484 + RU242) |
| 4 | RU484-RU242-RU242 (a size of a total frequency domain resource |
| | of the first user at all source layers is RU996) |
| 5 | RU484-RU484 (a size of a total frequency domain resource of the |
| | first user at both source layers is RU996) |
| 6 | RU484-RU484-RU484 (a size of a total frequency domain resource |
| | of the first user at all source layers is RU996 + RU484) |
| 7 | RU484-RU484-RU484-RU484 (a size of a total frequency domain |
| | resource of the first user at all source layers is RU2*996) |
| 8 | RU996-RU484 (a size of a total frequency domain resource of the |
| | first user at both source layers is RU996 + RU484) |
| 9 | RU996-RU484-RU242 (a size of a total frequency domain resource |
| | of the first user at all source layers is RU996 + RU484 + RU242) |
| 10 | RU996-RU996 (a size of a total frequency domain resource of the |
| | first user at both source layers is RU2*996) |
| 11 | RU996-RU484-RU484 (a size of a total frequency domain resource |
| | of the first user at all source layers is RU2*996) |
| 12 | RU996-RU996-RU484 (a size of a total frequency domain resource |
| | of the first user at all source layers is RU2*996 + RU484) |
| 13 | RU996-RU996-RU484-RU484 (a size of a total frequency domain |
| | resource of the first user at all source layers is RU3*996) |
| 14 | RU996-RU996-RU996 (a size of a total frequency domain resource |
| | of the first user at all source layers is RU3*996) |
| 15 | RU996-RU996-RU996-RU484 (a size of a total frequency domain |
| | resource of the first user at all source layers is RU3*996 + RU484) |
| 16 | RU996-RU996-RU996-RU996 (a size of a total frequency domain |
| | resource of the first user at all source layers is RU4*996) |

In addition to the combinations in the table, there may be other combinations, for example, RU484+242-RU242, and RU996+484-RU484. Resources at different source layers have different sizes. A larger resource may be allocated to an enhancement layer to carry more bits in a case of a low bit rate.

For another example, when sizes of the total frequency domain resource of the first user at all source layers are the same, values of the layer resource assignment field are different. For example, when the size of the total frequency domain resource of the first user at all source layers is RU2*996, for values of the layer resource assignment field, refer to Table 3. It can be seen from Table 3 that when the sizes of the total frequency domain resource of the first user at all the source layers are the same, different values of the layer resource assignment field may indicate different numbers of source layers of the first user. As shown in Table 3, when the value of the layer resource assignment field is 0, the number of source layers of the first user is 4, and sizes of layer frequency domain resources of the first user at the four source layers are all RU484. When the value of the layer resource assignment field is 1, the number of source layers of the first user is 2, and sizes of layer frequency domain resources of the first user at the two source layers are both RU996. When the value of the layer resource assignment field is 2, the number of source layers of the first user is 3, a size of a layer frequency domain resource of the first user at one source layer is RU996, and sizes of layer frequency domain resources of the first user at remaining source layers are both RU484. For another example, when the size of the total frequency domain resource of the first user at all source layers is RU3*996, for values of the layer resource assignment field, refer to Table 4. Description of Table 4 is similar to that of Table 3, and details are not described herein again.

TABLE 3

| Value of the | Number of source layers of the first user |
|---|---|
| layer resource | and the layer frequency domain resource |
| assignment field | of the first user at each source layer |
| 0 | RU484-RU484-RU484-RU484 |
| 1 | RU996-RU996 |
| 2 | RU996-RU484-RU484 |

TABLE 4

| Value of the | Number of source layers of the first user |
|---|---|
| layer resource | and the layer frequency domain resource |
| assignment field | of the first user at each source layer |
| 0 | RU996-RU996-RU484-RU484 |
| 1 | RU996-RU996-RU996 |

For the manner 8.1, in another possible implementation, the layer resource assignment field includes a number of layers field and an index field, the number of layers field is before or after the index field, the number of layers field indicates the number of source layers of the first user, and the index field indicates the layer frequency domain resource of the first user at each source layer. When the sizes of the total frequency domain resource of the first user at all the source layers are the same, a value of the index field varies with the number of source layers.

For example, it may be seen from Table 5 that when the number of source layers of the first user is 2, the value of the index field may be any one of 0 to 4. When the value of the index field is 0, sizes of layer frequency domain resources of the first user at the two source layers are both RU242. When the value of the index field is 1, a size of a layer frequency domain resource of the first user at one source layer is RU484, and a size of a layer frequency domain resource of the first user at the other source layer is RU242. Other values of the index field in Table 5 are similar, and details are not described herein again.

TABLE 5

| | Value of the | Layer frequency domain resource of |
|---|---|---|
| | index field | the first user at each source layer |
| The number | 0 | RU242-RU242 (a size of a total frequency |
| of source | | domain resource of the first user at both |
| layers of | | the source layers is RU484) |
| the first | 1 | RU484-RU242 (a size of a total frequency |
| user is 2 | | domain resource of the first user at both |
| | | the source layers is RU484 + RU242) |
| | 2 | RU484-RU484 (a size of a total frequency |
| | | domain resource of the first user at both |
| | | the source layers is RU484 + RU484) |
| | 3 | RU996-RU484 (a size of a total frequency |
| | | domain resource of the first user at both |
| | | the source layers is RU996 + RU484) |
| | 4 | RU996-RU996 (a size of a total frequency |
| | | domain resource of the first user at both |
| | | the source layers is RU996 + RU996) |

The manner 8.2 may be understood as follows: For a total RU or MRU, it is pre-specified in the standard that there is a unique allocation manner, and the layer frequency domain resource of the first user at each source layer does not need to be additionally indicated. Alternatively, for a total RU or MRU, a number of allocated layers is indicated, it is pre-specified in the standard that there is a unique allocation manner for the corresponding number of layers, and layer resource unit allocation does not need to be additionally indicated. To be specific, for the total RU or MRU, the number of source layers of the first user is further indicated, and numbers of source layers are different, but the layer frequency domain resource of each source layer for the number of layers is pre-specified in the standard. For example, when a size of a total frequency domain resource of the first user at all source layers is RU996, and the number of source layers of the first user is 2, the size corresponds to only RU484-RU484. That is, when the number of source layers of the first user is 2, sizes of layer frequency domain resources of the first user at the two source layers are both RU484.

For example, when the layer frequency domain resource of the first user at each source layer is the predefined frequency domain resource, in a possible implementation, the number of source layers of the first user is indicated by a second signal field of the first user. That is, the second signal field of the first user further includes a layer resource assignment field, and the layer resource assignment field indicates the number of source layers of the first user.

Optionally, in either the manner 6.1 or the manner 7.1, the first signal field of the first user is after a universal signal field and before a short training field, the universal signal field is on the total frequency domain resource of the first user at all the source layers, and the short training field is on the layer frequency domain resource at one source layer corresponding to the first user; or the first signal field of the first user is after a long training field and before a data field, and the long training field and the data field are on the layer frequency domain resource at one source layer corresponding to the first user. It can be learned that two trigger-based physical layer protocol data units in different formats are implemented. In addition, because the first signal field of the user using JSCC transmission is after the long training field and before the data field, and the long training field and the data field are on the layer frequency domain resource at the one source layer corresponding to the first user, a user not using JSCC transmission learns that a first signal field of the user not using JSCC transmission does not need to be transmitted when there is the user using JSCC transmission, thereby reducing overheads. In addition, a data field of the user not using JSCC transmission can transmit more data, thereby improving transmission efficiency.

When the first signal field of the first user is after the universal signal field and before the short training field, and when a second JSCC user learns, in the trigger frame, that a user needs to use JSCC transmission, a first signal field of the second user also needs to be transmitted, to ensure alignment of fields in RUs or MRUs. However, the first signal field of the second user may not carry any information, for example, may be all reserved fields or a pseudo-random sequence with a low peak-to-average ratio. In addition, like a universal signal field included in the trigger-based physical layer protocol data unit, the first signal field of the first user and the first signal field of the second user may be transmitted on a 20-megahertz (MHz) subchannel. Then, a length of the first signal field may be a fixed value or a variable value, and is indicated by the common information field or the special user information field in the trigger frame. For a bearing location, refer to a location of the user using joint source and channel coding.

When the first signal field of the first user is after the long training field and before the data field, and when a second JSCC user learns, in the trigger frame, that a user needs to use JSCC transmission, the first signal field of the second user does not need to be transmitted, so that a data field of a user not using JSCC transmission can transmit more data, thereby improving transmission efficiency.

Optionally, in either the manner 7.2 or the manner 7.3, the first signal field of the first user is after the long training field and before the data field.

In a possible implementation, the joint source and channel coding parameter of the one source layer corresponding to the first user may further include a length of a physical layer service data unit of the one source layer of the first user or a number of symbols carried in a data field corresponding to the one source layer of the first user. It can be learned that the first device may further learn of the length of the physical layer service data unit of the source layer or the number of symbols carried in the data field corresponding to the source layer of the first user, so that the first device may learn of a mapping relationship between the one source layer and data included in all source layers, to better parse data.

Optionally, in the trigger-based physical layer protocol data unit, the first user includes different source layers on an allocated time domain resource and/or frequency domain resource. For example, a user using joint source and channel coding may include different source layers only in time domain, or may include different source layers in both time domain and total frequency domain. It can be learned that because the first user includes the different source layers on the allocated time domain resource and/or frequency domain resource, a time-frequency resource can be better used to transmit data.

After step 703, step 704 and step 705 may be further performed. It should be understood that this solution may include step 701 to step 703, or this solution may include step 701 to step 704, or this solution may include step 701 to step 705. This is not limited herein. It may be understood that there is no necessary execution sequence between step 703 and step 704. In other words, step 704 may be performed before step 703, or may be performed after step 703, or may be performed simultaneously with step 703.

704: The third device sends the trigger-based physical layer protocol data unit of the second user, where the trigger-based physical layer protocol data unit includes non-joint source and channel coding data on a frequency domain resource allocated to the second user.

Correspondingly, the first device receives the trigger-based physical layer protocol data unit of the second user.

That the trigger-based physical layer protocol data unit includes the non-joint source and channel coding data on the frequency domain resource allocated to the second user may be understood as follows: The trigger-based physical layer protocol data unit includes a data field on the frequency domain resource allocated to the second user, and the data field includes the non-joint source and channel coding data.

705: The first device sends a multi-station block acknowledgment frame.

Correspondingly, the second device and the third device receive the multi-station block acknowledgment frame.

It can be learned that the user using JSCC transmission may correspond to one or more user information fields in the trigger frame. When the user using JSCC transmission corresponds to one user information field, the total frequency domain resource at all source layers may be allocated to the user, so that the trigger-based physical layer protocol data unit may include joint source and channel coding data on a layer frequency domain resource. This implements trigger-based joint source and channel coding transmission, reduces a number of user information fields, and further reduces overheads. When the user using JSCC transmission corresponds to a plurality of user information fields, a user information field indicates a layer frequency domain resource at a source layer, so that the trigger-based physical layer protocol data unit may include joint source and channel coding data on the layer frequency domain resource. This implements trigger-based joint source and channel coding transmission. In addition, for trigger-based joint source and channel coding transmission, a corresponding trigger-based physical layer protocol data unit is designed to enable an uplink multi-user JSCC transmission solution. This improves transmission efficiency of a system, and reduces a transmission delay.

In addition, in a possible implementation, the trigger frame in the embodiment shown in FIG. 7 may further include a JSCC padding field. Because JSCC transmission requires more complex joint source and channel coding, and requires more preparation time, the trigger frame may carry the JSCC padding field, so that the user using JSCC transmission has more processing time to prepare for JSCC transmission. Different users may need different processing time. When a user is associated with an AP, padding time required for JSCC transmission may be indicated by a capability field. For example, 0 indicates 8 microseconds, 1 indicates 16 microseconds, 2 indicates 32 microseconds, 3 indicates 64 microseconds, and 4 indicates 128 microseconds.

For example, when the second device is associated with the first device, the second device may indicate, by using the capability field, padding time required for JSCC transmission. Certainly, the second device may further report other padding time, for example, padding time required for multi-link device transmission. Specifically, processing time indicated by the JSCC padding field may further include processing time indicated by an enhanced multi-link multi-radio operation (enhanced multi-link multi-radio operation, EMLMR) padding delay (padding delay) field in 802.11be. In a possible implementation, the second device may separately report padding time required for JSCC transmission and other padding time, or the second device may report total time of padding time required for JSCC transmission and other padding time, or the second device may report longest time of padding time required for JSCC transmission and other padding time.

Optionally, the JSCC padding field may be considered as a part of a padding field in 802.11ax.

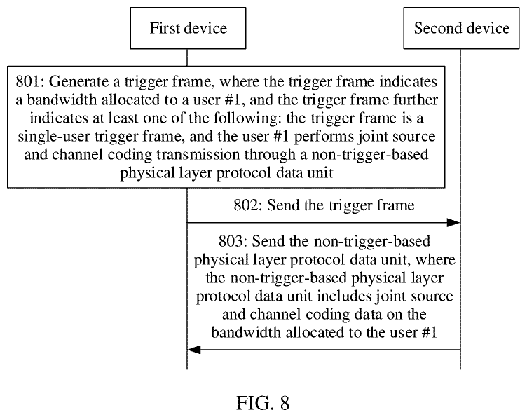

FIG. 8 is a schematic flowchart in which a single user performs non-trigger-based JSCC transmission according to an embodiment of this application. In FIG. 8, a user #1 is used as an example to describe a process in which a single user performs non-trigger-based JSCC transmission. As shown in FIG. 8, the method includes but is not limited to the following steps.

801: A first device generates a trigger frame, where the trigger frame indicates a bandwidth allocated to the user #1, and the trigger frame further indicates at least one of the following: The trigger frame is a single-user trigger frame, and the user #1 performs joint source and channel coding transmission through a non-trigger-based physical layer protocol data unit.

That the trigger frame indicates the bandwidth allocated to the user #1 may be understood as follows: The trigger frame includes a bandwidth field and an extended bandwidth field, and the bandwidth field and the extended bandwidth field indicate the bandwidth allocated to the user #1.

That the trigger frame is the single-user trigger frame and/or the user #1 performs joint source and channel coding transmission through the non-trigger-based physical layer protocol data unit may be implemented in any one of the following manners.

Manner 9.1: The trigger frame includes a common information field, and the common information field indicates at least one of the following: The trigger frame is the single-user trigger frame, and the user #1 performs joint source and channel coding transmission through the non-trigger-based physical layer protocol data unit. Some or all bits of reserved fields such as B55 to B62 and B63 in the common information field indicate at least one of the following: The trigger frame is the single-user trigger frame, and the user #1 performs joint source and channel coding transmission through the non-trigger-based physical layer protocol data unit. When the reserved field indicates at least one of the following: The trigger frame is the single-user trigger frame, and the user #1 performs joint source and channel coding transmission through the non-trigger-based physical layer protocol data unit, a name of the reserved field may be changed. A specific name is not limited.

Manner 9.2: The trigger frame includes a special user information field, and the special user information field indicates at least one of the following: The trigger frame is the single-user trigger frame, and the user #1 performs joint source and channel coding transmission through the non-trigger-based physical layer protocol data unit. For example, a reserved bit of the special user information field indicates at least one of the following: The trigger frame is the single-user trigger frame, and the user #1 performs joint source and channel coding transmission through the non-trigger-based physical layer protocol data unit, that is, some or all bits of B37 to B39 in the special user information field indicate at least one of the following: The trigger frame is the single-user trigger frame, and the user #1 performs joint source and channel coding transmission through the non-trigger-based physical layer protocol data unit.

Manner 9.3: The trigger frame includes a user information field corresponding to the user #1, and the user information field indicates at least one of the following: The trigger frame is the single-user trigger frame, and the user #1 performs joint source and channel coding transmission through the non-trigger-based physical layer protocol data unit. For example, B25 in the user information field indicates at least one of the following: The trigger frame is the single-user trigger frame, and the user #1 performs joint source and channel coding transmission through the non-trigger-based physical layer protocol data unit; and a reserved field is in B25.

Manner 9.4: The trigger frame includes a receiver address field, and the receiver address field indicates at least one of the following: The trigger frame is the single-user trigger frame, and the user #1 performs joint source and channel coding transmission through the non-trigger-based physical layer protocol data unit. A unicast address indicated by the receiver address field is an address of the user #1.

Optionally, the trigger frame may further include an uplink length (UL length) field, and the uplink length field indicates duration in which the user #1 can send, namely, duration in which the non-trigger-based physical layer protocol data unit can be transmitted.

802: The first device sends the trigger frame.

Correspondingly, a second device receives the trigger frame.

803: The second device sends the non-trigger-based physical layer protocol data unit, where the non-trigger-based physical layer protocol data unit includes joint source and channel coding data on the bandwidth allocated to the user #1.

Correspondingly, the first device receives the non-trigger-based physical layer protocol data unit.

Because the trigger frame is the single-user trigger frame, allocation of resources between users does not need to be considered, and alignment between fields or OFDM symbols, power control, and the like do not need to be considered. In addition, many parameters are determined by the user #1, and therefore may be reserved information in the trigger frame. For example, modulation and coding schemes and joint source and channel coding parameters of the user #1 at different source layers, a joint source and channel coding parameter shared by all source layers of the user #1, a number of source layers of the user #1, and the like may be determined by the user #1, that is, carried in the non-triggered-based physical layer protocol data unit. It should be understood that the trigger frame indicates the bandwidth allocated to the user #1, but does not provide resource allocation statuses of different source layers of the user #1. Therefore, the second device may allocate resource units to the different source layers in the non-triggered-based physical layer protocol data unit by using a first signal field.

In a possible implementation, the non-triggered-based physical layer protocol data unit includes the first signal field, the first signal field includes a resource allocation subfield and at least one user field corresponding to the user #1, and the resource allocation subfield indicates a frequency domain resource allocated to a user corresponding to each user field. The non-triggered-based physical layer protocol data unit further includes a second signal field of the user #1, the second signal field indicates a joint source and channel coding parameter of a source layer corresponding to the user #1, and the second signal field is on a frequency domain resource allocated to the user #1.

The resource allocation subfield indicates a layer frequency domain resource of the user corresponding to each user field at each source layer, or the resource allocation subfield indicates a total frequency domain resource of the user corresponding to each user field at all source layers. It should be understood that a frequency domain resource that is of the user #1 and that is indicated by the resource allocation subfield is included in the bandwidth allocated to the user #1.

Optionally, when the resource allocation subfield indicates the layer frequency domain resource of the user corresponding to each user field at each source layer, the user #1 corresponds to a plurality of user fields. When performing resource allocation based on the bandwidth allocated to the user #1, the second device may consider different source layers as data corresponding to different user fields, and allocate a corresponding RU or MRU to data of each source layer. In addition, the number of source layers of the user #1 is equal to a number of user fields that use a same station identifier field, and the station identifier field indicates the user #1. Alternatively, a second signal field of the user #1 further indicates at least one of the following: the number of source layers of the user #1 and an identifier of a source layer corresponding to the user #1. In a possible implementation, the second signal field of the user #1 includes a number of layers field, and the number of layers field indicates the number of source layers of the user #1. A second signal field of the user #1 includes a layer identifier field, and the layer identifier field indicates the identifier of the source layer corresponding to the user #1. In another possible implementation, the user field corresponding to the user #1 further indicates the number of source layers of the user #1. The user field corresponding to the user #1 includes a number of layers field, and the number of layers field indicates the number of source layers of the user #1.

Optionally, when the resource allocation subfield indicates the total frequency domain resource of the user corresponding to each user field at all the source layers, a second signal field of the user #1 further includes a layer resource assignment field, and the layer resource assignment field indicates at least one of the following: the number of source layers of the user #1, and a layer frequency domain resource of the user #1 at each source layer. Alternatively, a layer frequency domain resource of the user #1 at each source layer is a predefined frequency domain resource. For allocation of the layer frequency domain resource, refer to descriptions in the manner 8.1 and the manner 8.2. Details are not described herein again.

The joint source and channel coding parameters of the user #1 at the different source layers and/or the joint source and channel coding parameter shared by all the source layers of the user #1 may be implemented in any one of the following manners.

Manner 10.1: When the resource allocation subfield indicates the layer frequency domain resource of the user corresponding to each user field at each source layer, the joint source and channel coding parameter of the source layer corresponding to the user #1 may include at least one of the following: a joint source and channel coding parameter of a source layer corresponding to the user #1, and the joint source and channel coding parameter shared by all the source layers of the user #1. That is, a number of second signal fields of the user #1 is the same as the number of source layers of the user #1.

Manner 10.2: When the resource allocation subfield indicates the total frequency domain resource of the user corresponding to each user field at all the source layers, the joint source and channel coding parameter of the source layer corresponding to the user #1 may include at least one of the following: a joint source and channel coding parameter of each source layer corresponding to the user #1, and the joint source and channel coding parameter shared by all the source layers of the user #1. That is, a number of second signal fields of the user #1 is 1.

Manner 10.3: When the resource allocation subfield indicates the total frequency domain resource of the user corresponding to each user field at all the source layers, the second signal field of the user #1 may include a signal A field and at least one signal B field, the signal A field is on the total frequency domain resource of the user #1 at all the source layers, one signal B field is on a layer frequency domain resource of a source layer corresponding to the user #1, the signal A field indicates the joint source and channel coding parameter shared by all the source layers of the user #1, and the one signal B field indicates a joint source and channel coding parameter of the source layer corresponding to the user #1. That is, a number of second signal fields of the user #1 is 1.

In any one of the manner 10.1 to the manner 10.3, the joint source and channel coding parameter of the source layer corresponding to the user #1, the joint source and channel coding parameter shared by all the source layers of the user #1, and the like are similar to the joint source and channel coding parameter of the source layer corresponding to the first user and the joint source and channel coding parameter shared by all the source layers of the first user in the manner 6.1 in FIG. 7. Details are not described herein again.

Optionally, when the resource allocation subfield indicates the layer frequency domain resource of the user corresponding to each user field at each source layer, the modulation and coding schemes of the user #1 at the different source layers may be indicated by a plurality of user fields corresponding to the user #1, or the modulation and coding schemes of the user #1 at the different source layers may be indicated by the joint source and channel coding parameters of the user #1 at the different source layers. When the resource allocation subfield indicates the total frequency domain resource of the user corresponding to each user field at all the source layers, the modulation and coding schemes of the user #1 at the different source layers may be indicated by the joint source and channel coding parameters of the user #1 at the different source layers.

In a possible implementation, the joint source and channel coding parameter of the one source layer corresponding to the user #1 may further include a length of a physical layer service data unit of the source layer corresponding to the user #1, or a number of symbols carried in a data field corresponding to the source layer corresponding to the user #1.

Optionally, in the non-trigger-based physical layer protocol data unit, the user #1 includes different source layers on an allocated time domain resource and/or frequency domain resource. For example, a user using joint source and channel coding may include different source layers only in time domain, or may include different source layers in both time domain and frequency domain.

In another possible implementation, the non-trigger-based physical layer protocol data unit includes a third signal field and a fourth signal field, the fourth signal field includes a universal signal overflow field, the third signal field and/or the universal signal overflow field indicate/indicates that the physical layer protocol data unit is a PPDU for performing single-user Joint source and channel coding transmission, the fourth signal field further includes a resource allocation subfield, a layer block field, and a user field corresponding to the user #1, the resource allocation subfield indicates a layer frequency domain resource of the user #1 corresponding to the user field at each source layer, and the layer block field indicates a joint source and channel coding parameter of each source layer of the user corresponding to the user field.

Optionally, the layer block field may include a layer field corresponding to each source layer of the user corresponding to the user field, and one layer field indicates a joint source and channel coding parameter of one source layer of the user corresponding to the user field. The joint source and channel coding parameter of the one source layer of the user corresponding to the user field may include at least one of the following: a modulation and coding scheme of the one source layer of the user corresponding to the user field, and probability of source distribution of the one source layer of the user corresponding to the user field. In a possible implementation, the joint source and channel coding parameter of the one source layer of the user corresponding to the user field may further include a length of a physical layer service data unit of the one source layer of the user corresponding to the user field, or a number of symbols carried in a data field corresponding to the one source layer of the user corresponding to the user field. It should be understood that a number of data fields of the user corresponding to the user field is the same as a number of source layers of the user corresponding to the user field.

Optionally, the fourth signal field further includes a joint source and channel coding signal field, and the joint source and channel coding signal field indicates a joint source and channel coding parameter shared by all source layers of the user corresponding to the user field. The joint source and channel coding parameter shared by all the source layers of the user corresponding to the user field is similar to the joint source and channel coding parameter shared by all the source layers of the first user in the manner 6.1 in FIG. 7. Details are not described herein again.

It can be learned that because the trigger frame further indicates at least one of the following: the trigger frame is the single-user trigger frame, and the user performs joint source and channel coding transmission through the non-trigger-based physical layer protocol data unit, a user that receives the trigger frame may send the non-trigger-based physical layer protocol data unit, where the non-trigger-based physical layer protocol data unit includes the joint source and channel coding data on the bandwidth allocated to the user. This implements uplink single-user JSCC transmission. In addition, because the trigger frame is the single-user trigger frame, allocation of resources between users does not need to be considered, and alignment between fields or OFDM symbols, power control, and the like do not need to be considered. This reduces overheads. In addition, a user that receives the non-trigger-based physical layer protocol data unit may perform decoding based on a unified frequency domain resource size.

It should be noted that, in the embodiment shown in FIG. 7 or FIG. 8, if an AP requires a STA to perform JSCC transmission, different rules may be formulated in a standard for whether the STA performs JSCC transmission. The STA may be forced to perform JSCC transmission. Alternatively, the STA itself determines whether to perform JSCC transmission. If the STA does not want to perform JSCC transmission, in FIG. 7, whether the STA performs JSCC transmission may be indicated by the universal signal field in the trigger-based physical layer protocol data unit, or in FIG. 8, whether the STA performs JSCC transmission may be indicated by the third signal field or the universal signal overflow field in the non-trigger-based physical layer protocol data unit.

The following describes several possible frame structures of a PPDU in embodiments of this application with reference to accompanying drawings. It should be noted that in this application, XT is a standard code of a future-generation standard, and a specific name is not limited.

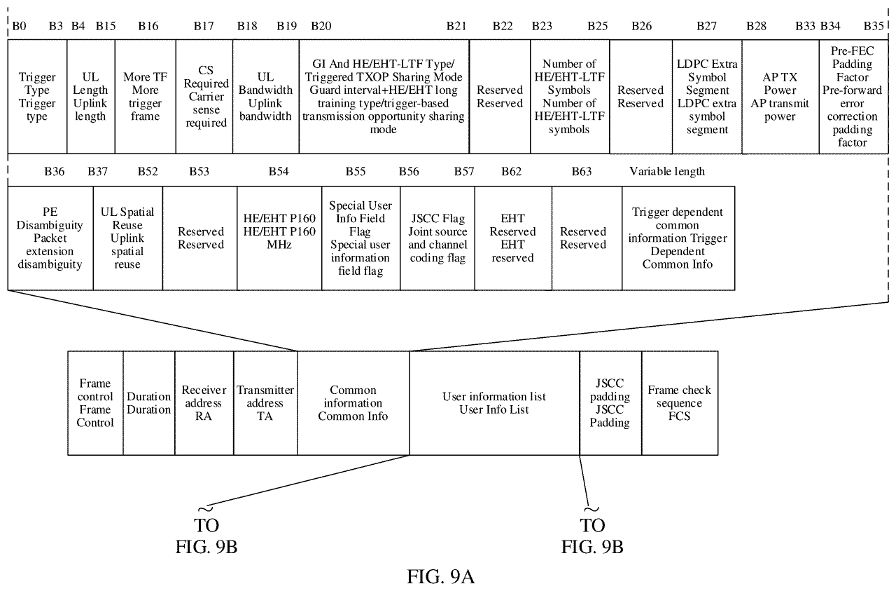

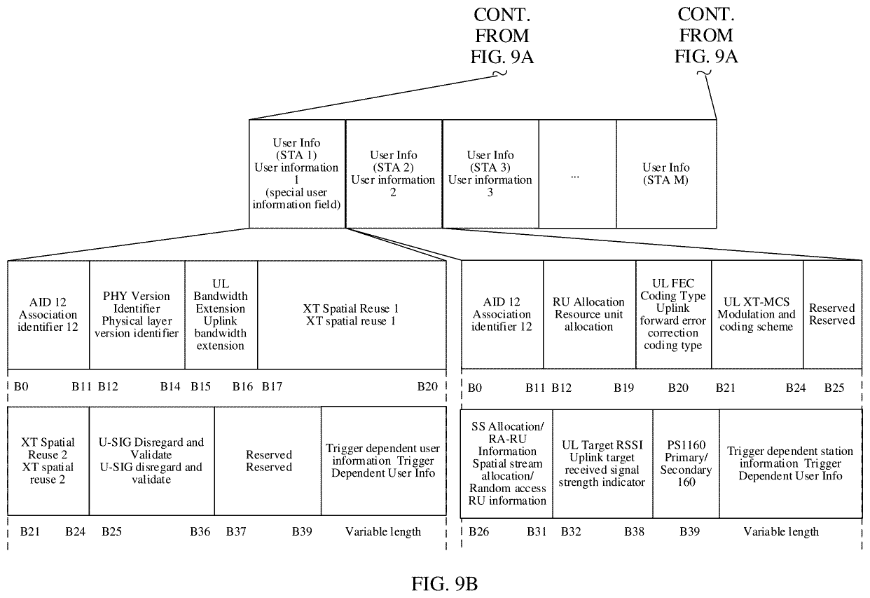

For example, for a frame structure of the trigger frame in the embodiment shown in FIG. 7, refer to FIG. 9A and FIG. 9B. In FIG. 9A and FIG. 9B, one JSCC user corresponds to a plurality of user information fields, and one non-JSCC user corresponds to one user information field. Alternatively, in FIG. 9A and FIG. 9B, one JSCC user corresponds to one user information field, and one non-JSCC user corresponds to one user information field.

FIG. 9A and FIG. 9B show a frame structure of a trigger frame in a scenario in which one or more users perform trigger-based JSCC transmission according to an embodiment of this application. As shown in FIG. 9A and FIG. 9B, the trigger frame may include a common information (common info) field, the common information field may include a JSCC flag (JSCC Flag) field, and the JSCC flag field indicates that there is a user using joint source and channel coding in the one or more users. In addition, the common information field may further include other fields, such as a trigger type (trigger type) field, an uplink length (UL length) field, a more trigger frame (more TF) field, a carrier sense required (CS required) field, an uplink bandwidth (UL bandwidth) field, a guard interval and HE/EHT long training type/trigger-based transmission opportunity sharing mode (GI and HE/EHT-LTF type/triggered TXOP sharing mode) field, a reserved (reserved) field in B22, a number of HE/EHT-LTF symbols (number of HE/EHT-LTF symbols) field, a reserved field in B26, a binary low-density parity-check extra symbol segment (LDCP extra symbol segment) field, an AP transmit power (AP TX power) field, a pre-forward error correction padding factor (pre-FEC padding factor) field, a packet extension disambiguity (PE disambiguity) field, an uplink spatial reuse (UL spatial reuse) field, a reserved field in B53, an HE/EHT P160 (HE/EHT P160) field, a special user information field flag (special user info field flag) field, an EHT reserved field, a trigger dependent common information (trigger dependent common info) field, and the like.

Optionally, the trigger frame in FIG. 9A may further include a user information list (User Info List) field, and the user information list field may include a special user information field, a user information 2 field, a user information 3 field, and the like.

The special user information field is a user information 1 field in FIG. 9B. For a function of the user information 1 field in FIG. 9B, refer to a function of the special user information field in the manner 1.2 in FIG. 7. Then, the user information 1 field in FIG. 9B may include a physical layer version identifier (PHY Version Identifier) field, and the physical layer version identifier field indicates an XT version. The user information 1 field in FIG. 9B may further include at least one of the following: an association identifier 12 field, an uplink bandwidth extension (UL bandwidth extension) field, an XT spatial reuse 1 (XT spatial reuse 1) field, an XT spatial reuse 2 (XT spatial reuse 2) field, a universal signal disregard and validate (U-SIG disregard and validate) field, a reserved field, and a trigger dependent user information (trigger dependent user info) field.

Optionally, a plurality of user information fields corresponding to a same JSCC user may use a same AID 12. For example, the user information 2 field and the user information 3 field may use a same AID 12 field. Then, the user information field may include a modulation and coding scheme field. The JSCC user corresponds to a plurality of user information fields. For a function of a modulation and coding scheme field included in one user information field corresponding to the JSCC user, refer to the manner 2.1, the manner 3.1, the manner 3.2, the manner 4.1 to the manner 4.3, and the like in FIG. 7. For example, in the manner 2.1, the modulation and coding scheme field indicates a special modulation and coding scheme. The JSCC user corresponds to one user information field. For a function of a modulation and coding scheme field included in the one user information field corresponding to the JSCC user, refer to the manner 2.1, the manner 2.4, the manner 3.1, the manner 3.2, the manner 5.1, the manner 5.2, and the like in FIG. 7. With reference to FIG. 9B, it can be learned that the user information 2 field and the user information 3 field each include an uplink XT-modulation and coding scheme field, the uplink XT-modulation and coding scheme field indicates a special modulation and coding scheme, and the uplink XT-modulation and coding scheme field is a modulation and coding scheme field corresponding to the first user in FIG. 7.

The JSCC user corresponds to a plurality of user information fields, and a user information field corresponding to the JSCC user indicates a layer frequency domain resource of the first user at a source layer. For example, a resource unit allocation (RU allocation) field and a primary/secondary 160 (PS160) field in the user information 2 field indicate a layer frequency domain resource of a user corresponding to the user information 2 field at a source layer, and a resource allocation unit field and a primary/secondary 160 field in the user information 3 field indicate a layer frequency domain resource of a user corresponding to the user information 3 field at a source layer. The JSCC user corresponds to a user information field, and the user information field corresponding to the JSCC user indicates a total frequency domain resource of the first user at all source layers.

The JSCC user corresponds to a user information field, and the user information field corresponding to the JSCC user may further include a number of layers (number of layers) field in B40 and B41. For a function of the number of layers field, refer to the manner 2.4 in FIG. 7. The number of layers field is not shown in FIG. 9A or FIG. 9B.

In addition, the user information 2 field, the user information 3 field, and the like in FIG. 9B each may further include at least one of the following: an uplink forward error correction coding type (UL FEC coding type) field, a reserved field, a spatial stream allocation/random access resource unit information (SS allocation/RA-RU information) field, an uplink target received signal strength indicator information (UL target RSSI) field, and a trigger dependent user information (trigger dependent user info) field.

Optionally, the trigger frame in FIG. 9A and FIG. 9B may also include a user information field corresponding to a non-JSCC user. This is not shown in FIG. 9A and FIG. 9B. The user information field corresponding to the non-JSCC user may include at least one of the following: an AID 12 field, an uplink XT-modulation and coding scheme field, a resource allocation unit field, a primary/secondary 160 field, an uplink forward error correction coding type field, a reserved field, a spatial stream allocation/random access resource unit information field, an uplink target received signal strength indicator information field, and a trigger dependent user information field. The uplink XT-modulation and coding scheme field is a modulation and coding scheme field corresponding to the second user in FIG. 7. The resource unit allocation field and the primary/secondary 160 field jointly indicate a frequency domain resource allocated to the non-JSCC user. For details, refer to the frequency domain resource allocated to the second user in FIG. 7.

Optionally, the trigger frame in FIG. 9A and FIG. 9B may further include a JSCC padding field. For a function of the JSCC padding field, refer to a function of the JSCC padding field in FIG. 7. Details are not described herein again. In addition, the trigger frame may further include at least one of the following: a frame control (frame control) field, a duration (duration) field, a receiver address (RA) field, a transmitter address (TA) field, and a frame check sequence (FCS) field.

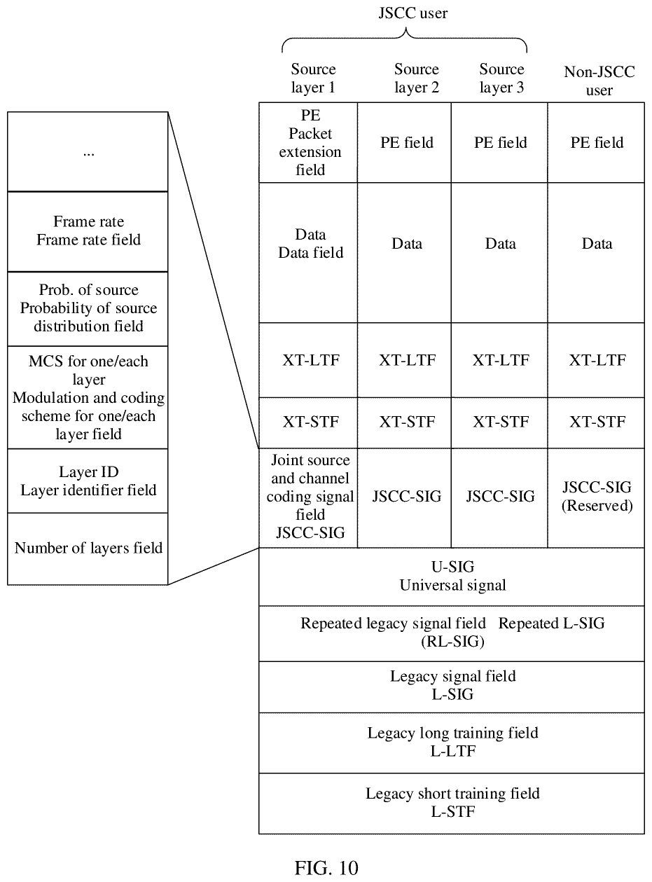

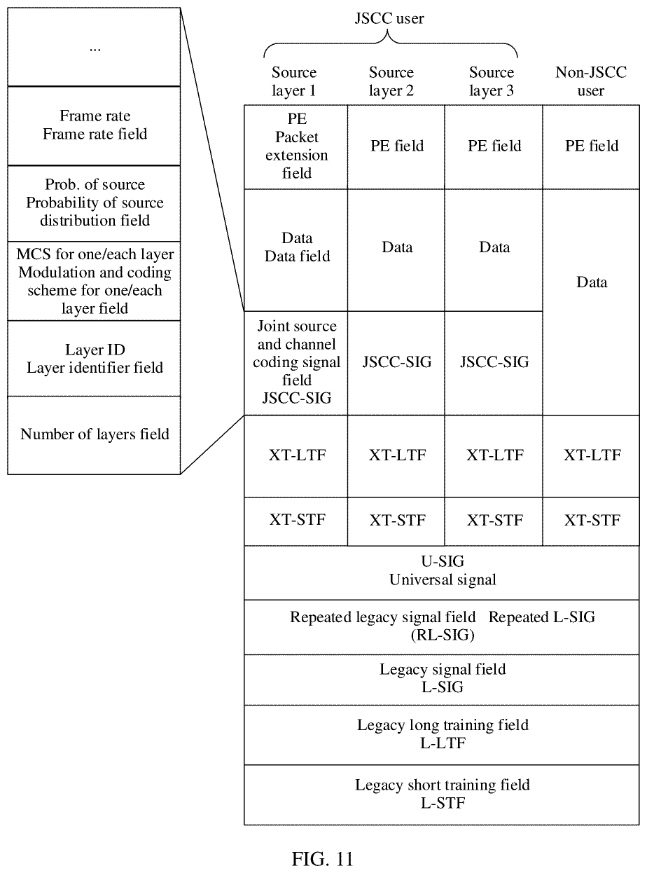

When the frame structure of the trigger frame shown in FIG. 9A and FIG. 9B is used to implement trigger-based JSCC transmission, and when in FIG. 9A and FIG. 9B, one JSCC user corresponds to a plurality of user information fields and one non-JSCC user corresponds to one user information field, for a frame structure of a trigger-based physical layer protocol data unit, refer to a frame structure shown in any one of FIG. 10 to FIG. 12. When the frame structure of the trigger frame shown in FIG. 9A and FIG. 9B is used to implement trigger-based JSCC transmission, and when in FIG. 9A and FIG. 9B, one JSCC user corresponds to one user information field and one non-JSCC user corresponds to one user information field, for a frame structure of a trigger-based physical layer protocol data unit, refer to a frame structure shown in any one of FIG. 11 and FIG. 13 to FIG. 17B. The JSCC user in FIG. 10 to FIG. 17B may be understood as the first user in FIG. 7, and the non-JSCC user in FIG. 10 to FIG. 17B may be understood as the second user in FIG. 7. A JSCC user corresponds to at least one source layer, and a non-JSCC user corresponds to one source layer. It should be understood that when the frame structure of the trigger frame shown in FIG. 9A and FIG. 9B is used to implement trigger-based JSCC transmission, and when in FIG. 9A and FIG. 9B, the one JSCC user corresponds to the one user information field and the one non-JSCC user corresponds to the one user information field, a frame structure shown in FIG. 11 corresponds to a case in which a layer frequency domain resource of the JSCC user at each source layer is a predefined frequency domain resource.

FIG. 10 shows a frame structure of a trigger-based physical layer protocol data unit according to an embodiment of this application in a case in which the frame structure of the trigger frame shown in FIG. 9A and FIG. 9B is used. As shown in FIG. 10, the physical layer protocol data unit includes a joint source and channel coding signal (JSCC-SIG) field of a JSCC user at each source layer. A JSCC-SIG field of the JSCC user at one source layer in FIG. 10 may be a first signal field of the first user in FIG. 7. With reference to FIG. 10, it can be seen that the JSCC user in FIG. 10 corresponds to three source layers. A JSCC-SIG field of the JSCC user at one source layer in FIG. 10 may include at least one of the following: a number of layers field and a layer identifier (layer ID) field. For example, for a JSCC-SIG field of the JSCC user at a source layer 1, a number of layers field indicates a number of source layers of the JSCC user, and a layer identifier field indicates an identifier of the source layer 1 corresponding to the JSCC user.

A JSCC-SIG field of the JSCC user at one source layer in FIG. 10 may further indicate a joint source and channel coding parameter of the JSCC user at one source layer and a joint source and channel coding parameter shared by all source layers of the JSCC user. For example, as shown in FIG. 10, a JSCC-SIG field of the JSCC user at one source layer may further include at least one of the following: a modulation and coding scheme for one/each layer (MCS for one/each layer) field, a probability of source distribution (prob. of source) field, a frame rate (frame rate) field, and the like. It should be understood that FIG. 10 shows only some fields included in the JSCC-SIG field of the JSCC user at one source layer.

The physical layer protocol data unit may further include a JSCC-SIG field of a non-JSCC user at one source layer, and the JSCC-SIG field of the non-JSCC user at the one source layer may be a first signal field of the second user in FIG. 7. That is, the JSCC-SIG field of the non-JSCC user at the one source layer may not carry any information, for example, may be all reserved fields or a pseudo-random sequence with a low peak-to-average ratio.

In addition, the physical layer protocol data unit may further include at least one of the following: a legacy short training field (legacy short training field, L-STF), a legacy long training field (legacy long training field, L-LTF), a legacy signal field (legacy signal field, L-SIG), a repeated legacy signal field (repeated legacy signal field, RL-SIG), a universal signal field (universal signal field, U-SIG), an XT-STF field of the JSCC user at each source layer, an XT-LTF field of the JSCC user at each source layer, a data field of the JSCC user at each source layer, a packet extension (packet extension, PE) field of the JSCC user at each source layer, an XT-STF field of the non-JSCC user at the one source layer, an XT-LTF field of the non-JSCC user at the one source layer, a data field of the non-JSCC user at the one source layer, and a packet extension field of the non-JSCC user at the one source layer.

FIG. 11 shows a frame structure of another trigger-based physical layer protocol data unit according to an embodiment of this application in a case in which the frame structure of the trigger frame shown in FIG. 9A and FIG. 9B is used. The frame structure of the physical layer protocol data unit shown in FIG. 10 is similar to that shown in FIG. 11, and a difference is as follows:
1. In the physical layer protocol data unit shown in FIG. 10, the JSCC-SIG field is after the universal signal field and before the XT-STF field. In the frame structure of the physical layer protocol data unit shown in FIG. 11, a JSCC-SIG field is after an XT-LTF field and before a data field.
2. In the physical layer protocol data unit shown in FIG. 10, the non-JSCC user corresponds to one JSCC-SIG field. In the frame structure of the physical layer protocol data unit shown in FIG. 11A, a non-JSCC user has no JSCC-SIG field.

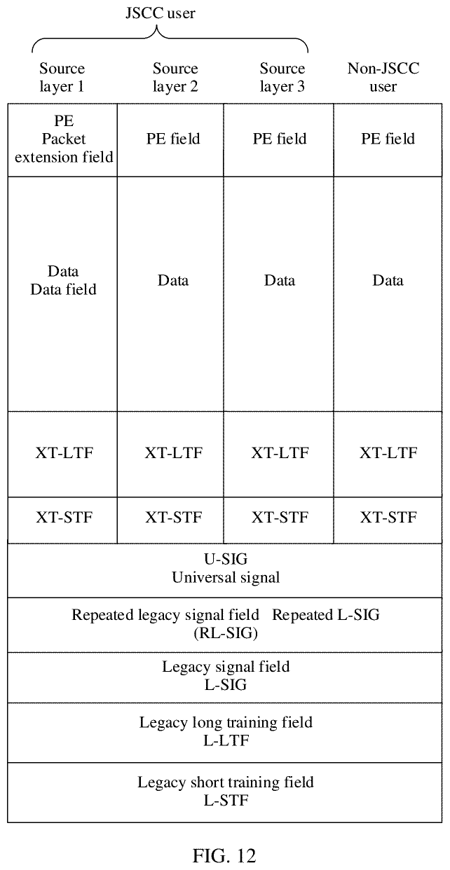

FIG. 12 shows a frame structure of another trigger-based physical layer protocol data unit according to an embodiment of this application in a case in which the frame structure of the trigger frame shown in FIG. 9A and FIG. 9B is used. The frame structure of the physical layer protocol data unit shown in FIG. 12 is similar to that shown in FIG. 11, and a difference is as follows: The physical layer protocol data unit shown in FIG. 11 includes a JSCC-SIG field on a layer frequency domain resource of the JSCC user at each source layer, where one JSCC-SIG field includes a joint source and channel coding parameter of one source layer corresponding to the JSCC user, and a joint source and channel coding parameter shared by all source layers of the JSCC user; and the physical layer protocol data unit shown in FIG. 11 includes a data field on the layer frequency domain resource of the JSCC user at each source layer, where one data field includes joint source and channel coding data of one source layer of the JSCC user; however, the physical layer protocol data unit shown in FIG. 12 has no JSCC-SIG field; and the physical layer protocol data unit shown in FIG. 12 includes a data field on a layer frequency domain resource of the JSCC user at each source layer, where one data field includes joint source and channel coding data of one source layer of the JSCC user, and the data field further includes a joint source and channel coding parameter of the source layer corresponding to the JSCC user, and a joint source and channel coding parameter shared by all source layers of the JSCC user.

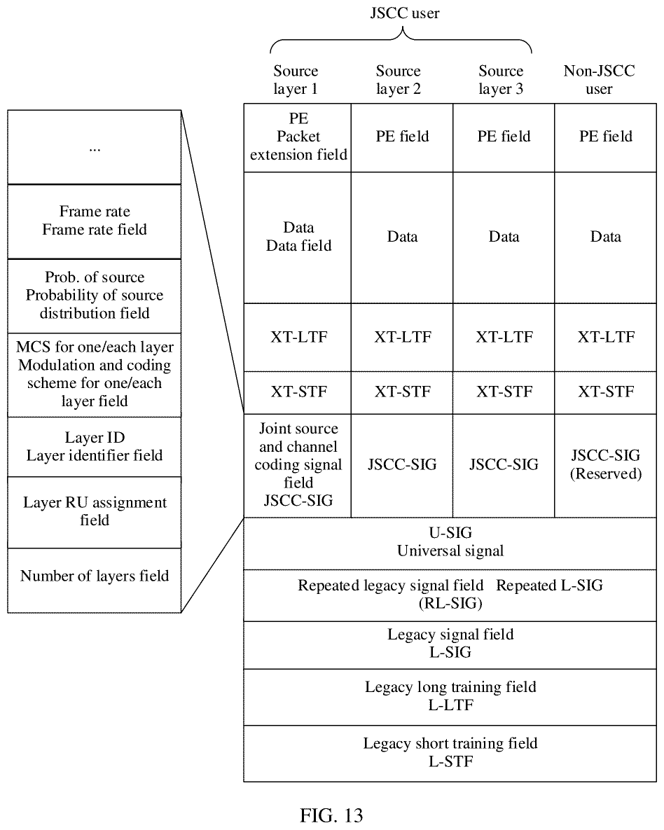

FIG. 13 shows a frame structure of another trigger-based physical layer protocol data unit according to an embodiment of this application in a case in which the frame structure of the trigger frame shown in FIG. 9A and FIG. 9B is used. The frame structure of the physical layer protocol data unit shown in FIG. 13 is similar to that shown in FIG. 10, and a difference is as follows: The physical layer protocol data unit shown in FIG. 13 further includes a layer RU allocation field, and a function of the layer RU allocation field may be a function of the layer resource assignment field in the manner 8.1 in FIG. 7.

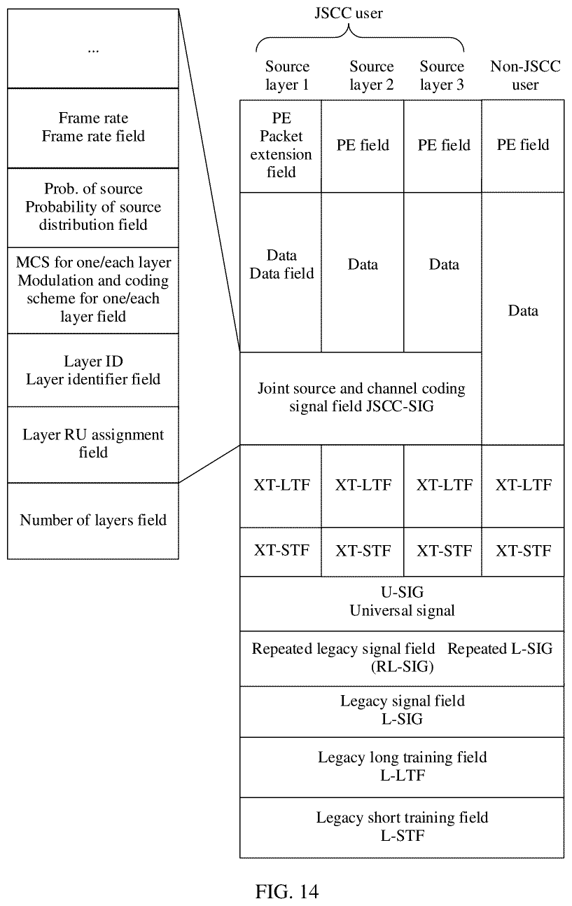

FIG. 14 shows a frame structure of another trigger-based physical layer protocol data unit according to an embodiment of this application in a case in which the frame structure of the trigger frame shown in FIG. 9A and FIG. 9B is used. The frame structure of the physical layer protocol data unit shown in FIG. 14 is similar to that shown in FIG. 11, and a difference is as follows: In the physical layer protocol data unit shown in FIG. 11, one JSCC user corresponds to one JSCC-SIG field at one source layer, one JSCC-SIG field may indicate a joint source and channel coding parameter of the JSCC user at one source layer and a joint source and channel coding parameter shared by all source layers of the JSCC user, and the JSCC-SIG field includes no layer RU allocation field; however, in the physical layer protocol data unit shown in FIG. 14, one JSCC user corresponds to one JSCC-SIG field, the one JSCC-SIG field corresponding to the one JSCC user is on the total frequency domain resource of the JSCC user at all source layers, the JSCC-SIG field may include a layer RU allocation field, a function of the layer RU allocation field may be a function of the layer resource assignment field in the manner 8.1 in FIG. 7, and the JSCC-SIG field may further indicate a joint source and channel coding parameter of the JSCC user at each source layer and a joint source and channel coding parameter shared by all the source layers of the JSCC user.

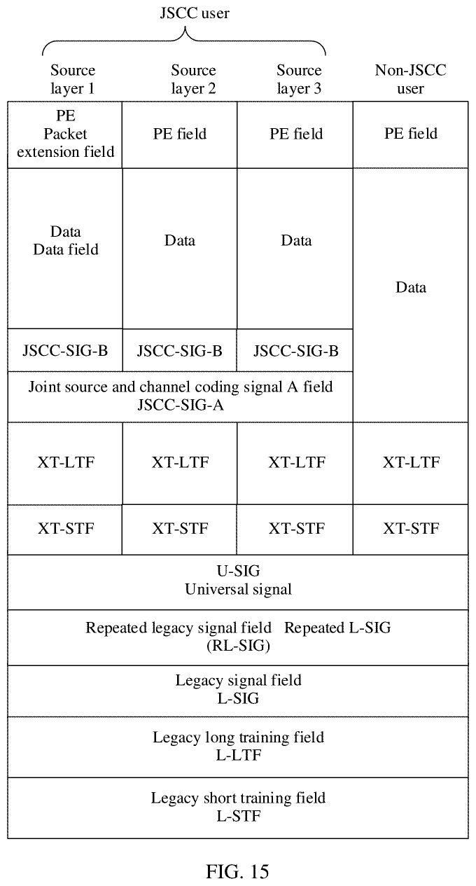

FIG. 15 shows a frame structure of another trigger-based physical layer protocol data unit according to an embodiment of this application in a case in which the frame structure of the trigger frame shown in FIG. 9A and FIG. 9B is used. The frame structure of the physical layer protocol data unit shown in FIG. 15 is similar to that shown in FIG. 14, and a difference is as follows: In the physical layer protocol data unit shown in FIG. 14, one JSCC user corresponds to one JSCC-SIG field at all source layers, the one JSCC-SIG field may include a layer RU allocation field, a function of the layer RU allocation field may be a function of the layer resource assignment field in the manner 8.1 in FIG. 7, and one JSCC-SIG field may further indicate a joint source and channel coding parameter of the JSCC user at each source layer and a joint source and channel coding parameter shared by all source layers of the JSCC user; however, in the physical layer protocol data unit shown in FIG. 15, one JSCC user corresponds to one JSCC-SIG-A field at all source layers, the one JSCC user corresponds to one JSCC-SIG-B field at one source layer, the JSCC-SIG-A field may include a layer RU allocation field, a function of the layer RU allocation field may be a function of the layer resource assignment field in the manner 8.1 in FIG. 7, the JSCC-SIG-A field indicates a joint source and channel coding parameter shared by all source layers of the JSCC user, and one JSCC-SIG-B field indicates a joint source and channel coding parameter of the JSCC user at one source layer.

It should be noted that when a layer frequency domain resource of the JSCC user at each source layer is a predefined frequency domain resource, the layer RU allocation field in FIG. 15 may be omitted.

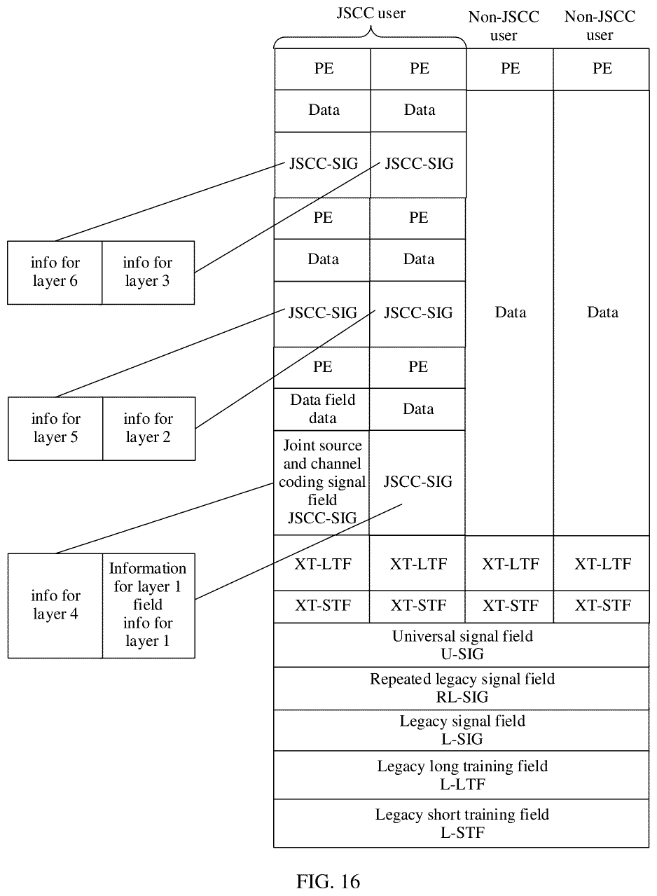

When the frame structure of the trigger frame shown in FIG. 9A and FIG. 9B is used to implement trigger-based JSCC transmission, and the JSCC user includes different source layers on an allocated time domain resource and/or frequency domain resource, for the frame structure of the trigger-based physical layer protocol data unit, refer to FIG. 16. FIG. 16 shows a frame structure of a trigger-based physical layer protocol data unit during carrying different source layers on a time-frequency resource according to an embodiment of this application. The frame structure of the physical layer protocol data unit shown in FIG. 16 is similar to that shown in FIG. 11, and a difference is as follows: In the physical layer protocol data unit shown in FIG. 11, one JSCC user includes only one source layer on a time-frequency resource, however, in the physical layer protocol data unit shown in FIG. 16, one JSCC user includes different source layers on a time-frequency resource.

In addition, for FIG. 10 to FIG. 15, one JSCC user may include different source layers on a time-frequency resource, and no example of the frame structure of the trigger-based physical layer protocol data unit is provided.

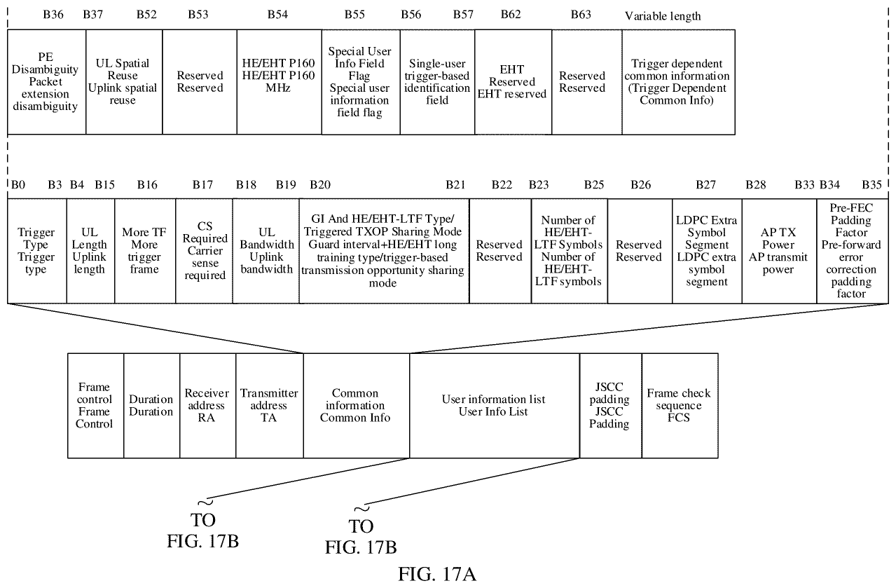

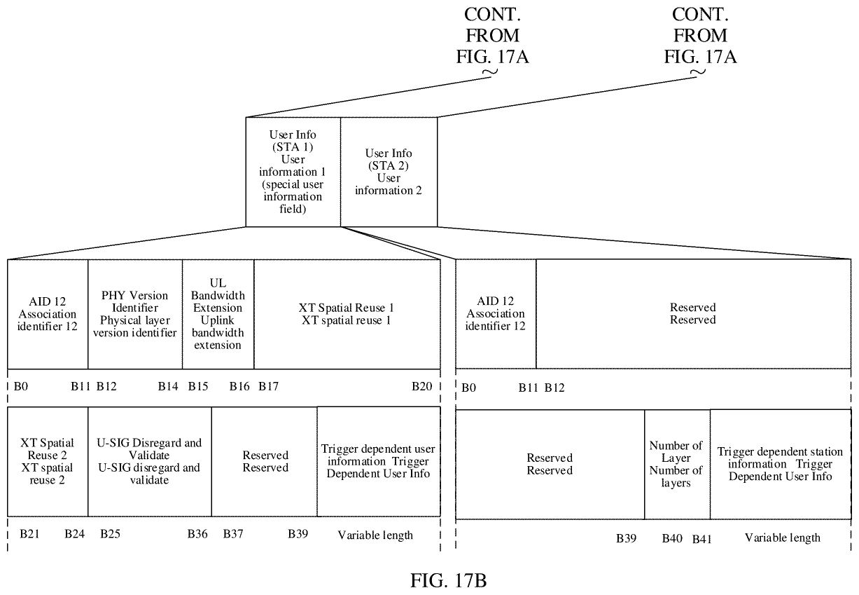

For example, for a frame structure of the trigger frame in the embodiment shown in FIG. 8, refer to FIG. 17A and FIG. 17B. In FIG. 17A and FIG. 17B, a JSCC user corresponds to a user information field.

FIG. 17A and FIG. 17B show a frame structure of a trigger frame in a scenario in which a single user performs non-trigger-based JSCC transmission according to an embodiment of this application. The frame structure of the trigger frame shown in FIG. 17A and FIG. 17B is similar to the frame structure of the trigger frame shown in FIG. 9A and FIG. 9B, and a difference is as follows:
1. The common information field in FIG. 9A may include the JSCC flag field, and the JSCC flag field indicates that there is a user using joint source and channel coding in one or more users; however, a common information field in FIG. 17A may include a single-user trigger-based identification field, and the single-user trigger-based identification field indicates at least one of the following: The trigger frame is a single-user trigger frame, and a user #1 performs joint source and channel coding transmission through a non-trigger-based physical layer protocol data unit.
2. An address indicated by the receiver address field in FIG. 9A is a broadcast address, however, an address indicated by a receiver address field in FIG. 17A is a single address.
3. The user information 1 field in FIG. 9B indicates that there is a user using joint source and channel coding in one or more users; however, a user information 1 field in FIG. 17B indicates at least one of the following: The trigger frame is the single-user trigger frame, and the user #1 performs joint source and channel coding transmission through the non-trigger-based physical layer protocol data unit.
4. A user information field in FIG. 9B may include at least one of the following: an AID 12 field, an uplink XT-modulation and coding scheme field, a resource allocation unit field, an uplink forward error correction coding type field, a reserved field, a spatial stream allocation/random access resource unit information field, a primary/secondary 160 field, an uplink target received signal strength indicator information field, and a trigger dependent user information field. In addition, the JSCC user corresponds to a user information field, and the user information field in FIG. 9B may further include a number of layers field. However, FIG. 17B includes only an AID 12 field, a number of layers field, a trigger dependent user information (trigger dependent user info) field, and other reserved fields.

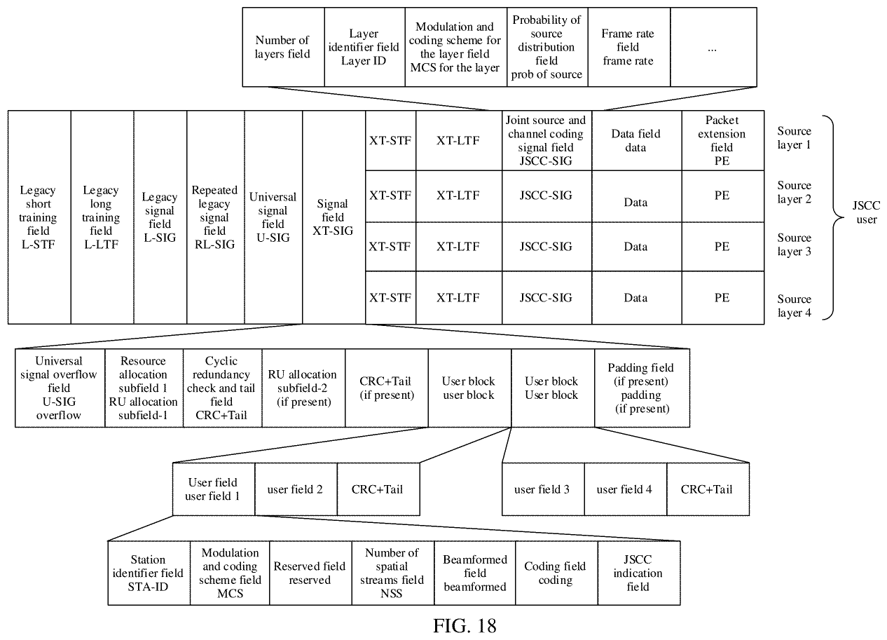

When the frame structure of the trigger frame shown in FIG. 17A and FIG. 17B is used to implement non-trigger-based JSCC transmission of a single user, for the frame structure of the non-trigger-based physical layer protocol data unit, refer to a frame structure shown in any one of FIG. 18 to FIG. 23. A JSCC user in FIG. 18 to FIG. 23 may be a user #1 in FIG. 8. In FIG. 18 to FIG. 22, a JSCC-SIG field may be a second signal field in FIG. 8, and an XT-SIG field may be understood as the first signal field in FIG. 8.

FIG. 18 shows a frame structure of a non-trigger-based physical layer protocol data unit according to an embodiment of this application in a case in which the frame structure of the trigger frame shown in FIG. 17A and FIG. 17B is used. As shown in FIG. 18, the physical layer protocol data unit may include a JSCC-SIG field of the JSCC user at each source layer. With reference to FIG. 18, it can be seen that the JSCC user corresponds to four source layers. A JSCC-SIG field at one source layer may include at least one of the following: a joint source and channel coding parameter of the one source layer corresponding to the JSCC user, or a joint source and channel coding parameter shared by all source layers of the JSCC user. For the joint source and channel coding parameter of the one source layer corresponding to the JSCC user, the joint source and channel coding parameter shared by all the source layers of the JSCC user, and the like, refer to related descriptions in FIG. 8.

In a possible implementation, a JSCC-SIG field at one source layer may further include a number of layers field and a layer identifier field, the number of layers field indicates a number of source layers of the JSCC user, the layer identifier field indicates an identifier of the one source layer corresponding to the JSCC user. In another possible implementation, a user information (user info) field corresponding to the JSCC user may include a number of layers field. This is not shown in FIG. 18.

The physical layer protocol data unit in FIG. 18 may further include an XT-SIG field. The XT-SIG field may include at least one of the following: a resource allocation subfield 1 (RU allocation subfield-1), a resource allocation subfield 2 (RU allocation subfield-2) (if present), and at least one user block (user block) (only two user blocks are shown in FIG. 18). Functions of the resource allocation subfield 1 and the resource allocation subfield 2 are the same as a function of the resource allocation subfield in FIG. 8. The XT-SIG field may further include at least one of the following: a universal signal overflow (U-SIG overflow) field, a cyclic redundancy check (cyclic redundancy check, CRC) and tail (tail) field, and a cyclic redundancy check and tail field (if present) padding (padding) (if present). One user block may include at least one user field (user field) and a cyclic redundancy check and tail field, and different user blocks use different cyclic redundancy check codes. As shown in FIG. 18, the user block after the cyclic redundancy check and tail field (if present) may include a user field 1, a user field 2, and the cyclic redundancy check and tail field. The user block before the padding field (if present) may include a user field 3, a user field 4, and a cyclic redundancy check and tail field.

The user field may include at least one of the following: a station identifier field (STA-ID) and a modulation and coding scheme (modulation and coding scheme, MCS) field. Different user fields corresponding to the JSCC user can use a same station identifier field. One modulation and coding scheme field indicates a modulation and coding scheme of the JSCC user at one source layer. In a possible implementation, the user field may further include at least one of the following: a reserved field (reserved), a number of spatial streams (number of spatial streams, NSS) field, a beamformed field (beamformed), and a coding (coding) field. As shown in FIG. 18, the user field 1 to the user field 4 each may include at least one of the following: a station identifier field and a modulation and coding scheme field; and the user field 1 to the user field 4 each may further include at least one of the following: a reserved field, a number of spatial streams field, a beamformed field, and a coding field. It should be understood that FIG. 18 shows only fields included in the user field 1.

In addition, the physical layer protocol data unit in FIG. 18 may further include at least one of the following: a legacy short training field (legacy short training field, L-STF), a legacy long training field (legacy long training field, L-LTF), a legacy signal field (legacy signal field, L-SIG), a repeated legacy signal field (repeated legacy signal field, RL-SIG), a universal signal field (universal signal field, U-SIG), an XT-STF field of the JSCC user at each source layer, an XT-LTF field of the JSCC user at each source layer, a data field of the JSCC user at each source layer, and a packet extension (packet extension, PE) field of the JSCC user at each source layer.

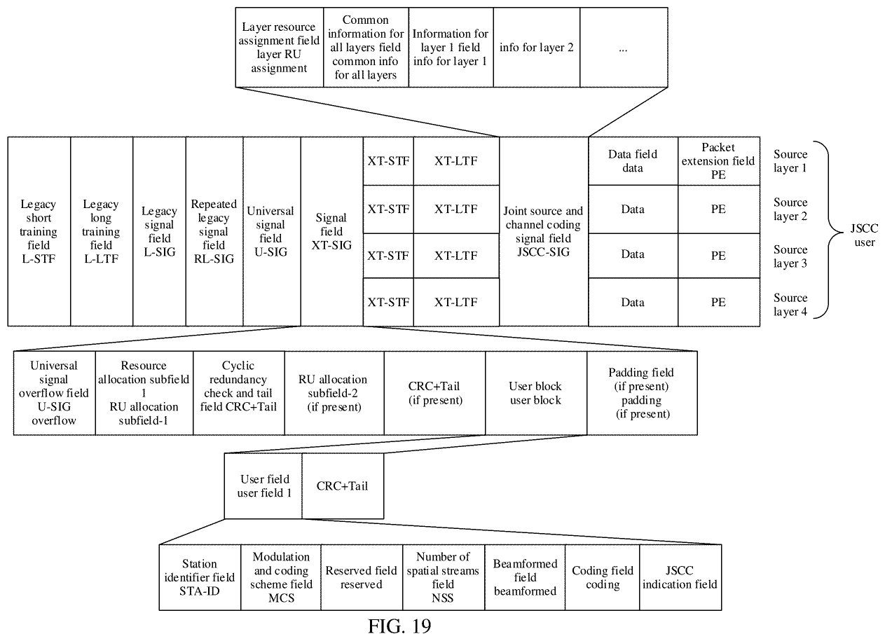

FIG. 19 shows a frame structure of another non-trigger-based physical layer protocol data unit according to an embodiment of this application in a case in which the frame structure of the trigger frame shown in FIG. 17A and FIG. 17B is used. The frame structure of the physical layer protocol data unit shown in FIG. 19 is similar to the frame structure of the physical layer protocol data unit shown in FIG. 18, and a difference is as follows:
1. In the physical layer protocol data unit shown in FIG. 18, one JSCC user corresponds to a plurality of user fields, however, in the physical layer protocol data unit shown in FIG. 19, one JSCC user corresponds to one user field.
2. In the physical layer protocol data unit shown in FIG. 18, one JSCC user corresponds to one JSCC-SIG field at one source layer, the one JSCC-SIG field may include a number of layers field and a layer identifier field, and the one JSCC-SIG field may further indicate a joint source and channel coding parameter of the JSCC user at the one source layer and a joint source and channel coding parameter shared by all source layers of the JSCC user; however, in the physical layer protocol data unit shown in FIG. 19, one JSCC user corresponds to one JSCC-SIG field at all source layers, the one JSCC-SIG field includes a layer resource assignment (layer RU assignment) field, and the one JSCC-SIG field may further indicate a joint source and channel coding parameter of the JSCC user at each source layer and a joint source and channel coding parameter shared by all source layers of the JSCC user. As shown in FIG. 19, a common information for all layers (common info for all layers) field indicates the joint source and channel coding parameter shared by all the source layers of the JSCC user. An information for layer 1 (info for layer) field indicates a joint source and channel coding parameter of the JSCC user at a source layer 1, and an information for layer 2 (info for layer) field indicates a joint source and channel coding parameter of the JSCC user at a source layer 2. It should be understood that FIG. 19 shows only two information fields for layer, and may further include another information field for layer. This is not limited herein.

It should be noted that when a layer frequency domain resource of the JSCC user at each source layer is a predefined frequency domain resource, the layer resource assignment field in FIG. 19 may be omitted.

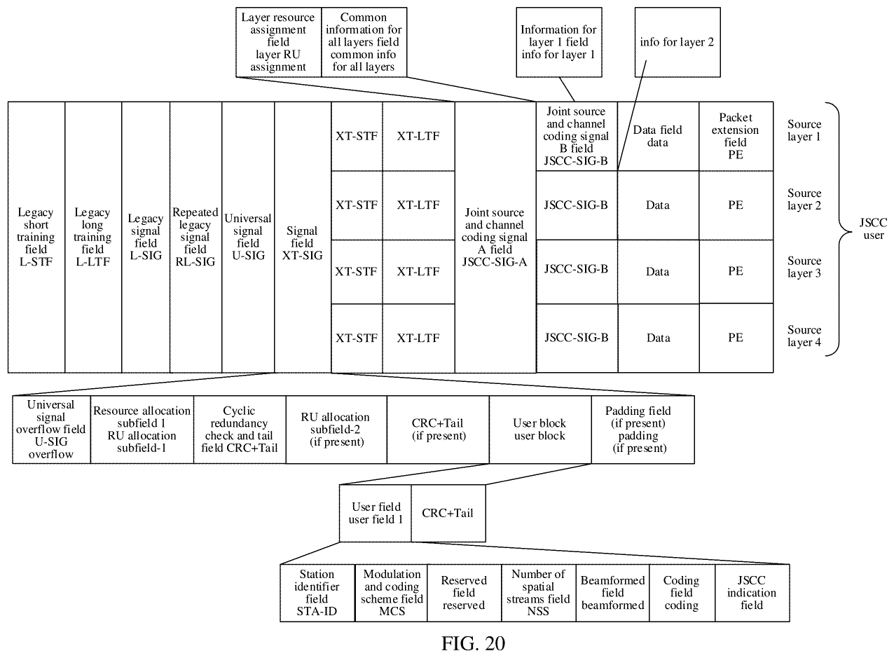

FIG. 20 shows a frame structure of another non-trigger-based physical layer protocol data unit according to an embodiment of this application in a case in which the frame structure of the trigger frame shown in FIG. 17A and FIG. 17B is used. The frame structure of the physical layer protocol data unit shown in FIG. 20 is similar to the frame structure of the physical layer protocol data unit shown in FIG. 18, and a difference is as follows: In the physical layer protocol data unit shown in FIG. 18, one JSCC user corresponds to one JSCC-SIG field at one source layers, the one JSCC-SIG field may include a layer resource assignment field, and the one JSCC-SIG field may further indicate a joint source and channel coding parameter of the JSCC user at each source layer and a joint source and channel coding parameter shared by all source layers of the JSCC user; however, in the physical layer protocol data unit shown in FIG. 20, one JSCC user corresponds to one JSCC-SIG-A field at all source layers, the one JSCC user corresponds to one JSCC-SIG-B field at one source layer, the JSCC-SIG-A field may include a layer resource assignment field, the JSCC-SIG-A field indicates a joint source and channel coding parameter shared by all source layers of the JSCC user, and one JSCC-SIG-B field indicates a joint source and channel coding parameter of the JSCC user at one source layer.

It should be noted that when a layer frequency domain resource of the JSCC user at each source layer is a predefined frequency domain resource, the layer resource assignment field in FIG. 20 may be omitted.

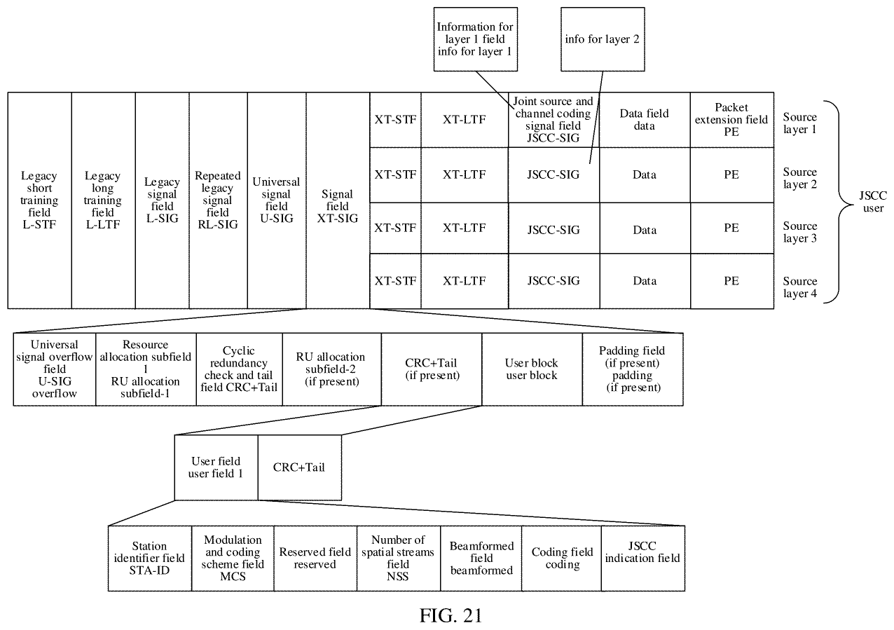

FIG. 21 shows a frame structure of another non-trigger-based physical layer protocol data unit according to an embodiment of this application in a case in which the frame structure of the trigger frame shown in FIG. 17A and FIG. 17B is used. The frame structure of the physical layer protocol data unit shown in FIG. 21 is similar to the frame structure of the physical layer protocol data unit shown in FIG. 18, and a difference is as follows: In the physical layer protocol data unit shown in FIG. 18, one JSCC user corresponds to one JSCC-SIG field at all source layers, the one JSCC-SIG field includes a layer resource assignment (layer RU assignment) field, and the one JSCC-SIG field may further indicate a joint source and channel coding parameter of the JSCC user at each source layer and a joint source and channel coding parameter shared by all source layers of the JSCC user; however, in the physical layer protocol data unit shown in FIG. 21, one JSCC user corresponds to one JSCC-SIG field at each source layer, one JSCC-SIG field does not include a layer resource assignment (layer RU assignment) field, one JSCC-SIG field may further indicate a joint source and channel coding parameter of the JSCC user at one source layer. For example, one JSCC-SIG field includes an information of layer 1 field, the information of layer 1 field indicates a joint source and channel coding parameter of the JSCC user at a source layer 1, and one JSCC-SIG field may further indicate a joint source and channel coding parameter shared by all source layers of the JSCC user.

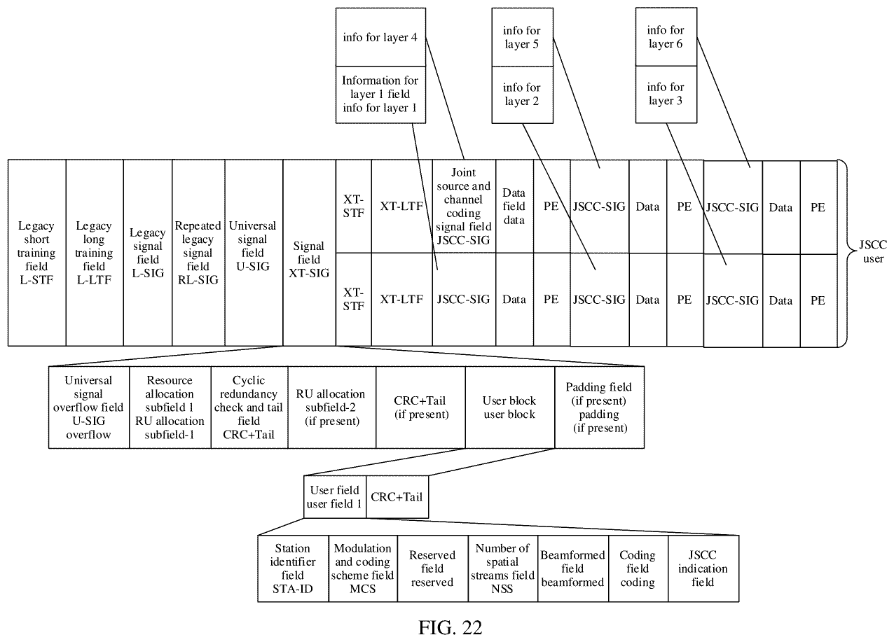

When the JSCC user includes different source layers on an allocated time domain resource and/or frequency domain resource, for the frame structure of the physical layer protocol data unit, refer to FIG. 22. FIG. 22 shows a frame structure of a non-trigger-based physical layer protocol data unit during carrying different source layers on a time-frequency resource according to an embodiment of this application in a case in which the frame structure of the trigger frame shown in FIG. 17A and FIG. 17B is used. The frame structure of the physical layer protocol data unit shown in FIG. 22 is similar to that shown in FIG. 21, and a difference is as follows: In the physical layer protocol data unit shown in FIG. 21, one JSCC user includes only one source layer on a time-frequency resource, however, in the physical layer protocol data unit shown in FIG. 22, one JSCC user includes different source layers on a time-frequency resource.

In addition, for FIG. 18 to FIG. 21, one JSCC user may include different source layers on a time-frequency resource, and no example of the frame structure of the physical layer protocol data unit is provided.

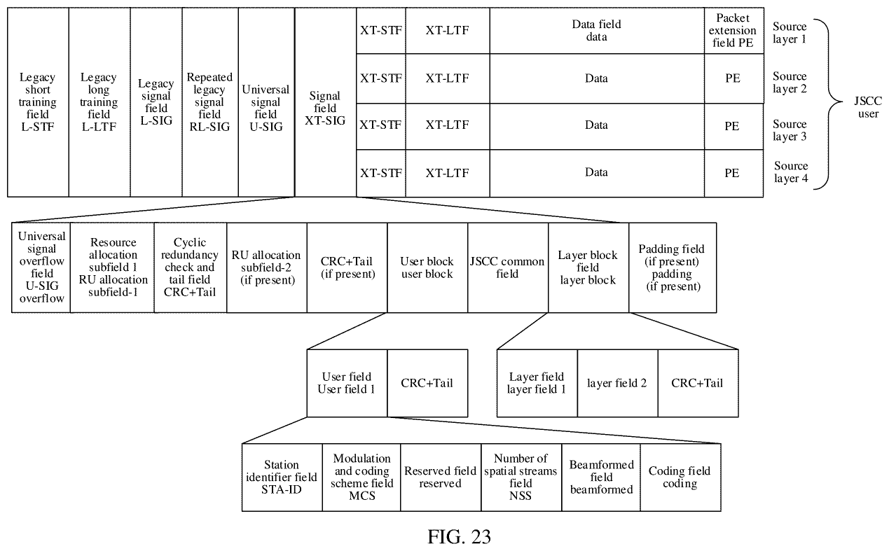

FIG. 23 shows a frame structure of another non-trigger-based physical layer protocol data unit according to an embodiment of this application in a case in which the frame structure of the trigger frame shown in FIG. 17A and FIG. 17B is used. The frame structure of the physical layer protocol data unit shown in FIG. 23 is similar to that shown in FIG. 18, and a difference is as follows:
1. The physical layer protocol data unit shown in FIG. 18 includes an XT-SIG field and a JSCC-SIG field of the JSCC user at each source layer, however, the physical layer protocol data unit shown in FIG. 23 includes no XT-SIG field.
2. The physical layer protocol data unit shown in FIG. 18 includes at least one user block, and the one user block may include at least one user field; however, the frame structure of the PPDU shown in FIG. 23 includes a user block, and the user block includes a user field.
3. The physical layer protocol data unit shown in FIG. 18 does not include a JSCC common field or a layer block (layer block) field; however, the physical layer protocol data unit shown in FIG. 23 includes a JSCC common field and a layer block field, the JSCC common field is a joint source and channel coding signal field in FIG. 8, the layer block field may include at least one layer field (layer field) and a cyclic redundancy check and tail field, and the layer field indicates a joint source and channel coding parameter of a user corresponding to the one user field at one source layer. As shown in FIG. 23, the layer block field may include a layer field 1 and a layer field 2. The layer block field 1 indicates a joint source and channel coding parameter of the user corresponding to the user field at a source layer 1. The layer block field 2 indicates a joint source and channel coding parameter of the user corresponding to the user field at a source layer 2.
4. In the physical layer protocol data unit shown in FIG. 18, a universal signal field and/or a universal signal overflow field indicate/indicates that the physical layer protocol data unit is a PPDU for performing joint source and channel coding transmission; however, in the physical layer protocol data unit shown in FIG. 23, a universal signal field and/or a universal signal overflow field indicate/indicates that the physical layer protocol data unit is a PPDU for performing single-user joint source and channel coding transmission.

It should be noted that an XT-SIG field in FIG. 23 may be the fourth signal field in FIG. 8, and the U-SIG field in FIG. 23 is the third signal field in FIG. 8.

The foregoing mainly describes the solutions provided in this application from a perspective of interaction between devices. It may be understood that in the foregoing implementations, to implement the foregoing functions, each device includes a corresponding hardware structure and/or software module for performing each function. A person skilled in the art should be easily aware that, in combination with units and algorithm steps of the examples described in embodiments disclosed in this specification, this application may be implemented in a form of hardware or a combination of hardware and computer software. Whether a function is performed by hardware or hardware driven by computer software depends on particular applications and design constraints of the technical solutions. A person skilled in the art may use different methods to implement the described functions for each particular application, but it should not be considered that the implementation goes beyond the scope of this application.

In embodiments of this application, the AP or the STA may be divided into functional modules based on the foregoing method examples. For example, each functional module may be obtained through division based on a corresponding function, or two or more functions may be integrated into one processing module. The integrated module may be implemented in a form of hardware, or may be implemented in a form of a software functional module. It should be noted that, in embodiments of this application, division into modules is an example, and is merely logical function division. During actual implementation, another division manner may be used.

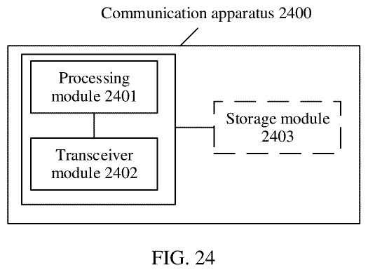

If the integrated module is used, refer to FIG. 24. FIG. 24 is a diagram of a structure of a communication apparatus according to an embodiment of this application. The communication apparatus 2400 may be used in the methods shown in FIG. 7 and FIG. 8. As shown in FIG. 24, the communication apparatus 2400 includes a processing module 2401 and a transceiver module 2402. The processing module 2401 may be one or more processors, and the transceiver module 2402 may be a transceiver or a communication interface. The communication apparatus may be configured to implement the AP or the STA in any one of the foregoing method embodiments, or configured to implement functions of the network element in any one of the foregoing method embodiments. The network element or network function may be a network element in a hardware device, a software function running on dedicated hardware, or a virtualization function instantiated on a platform (for example, a cloud platform). Optionally, the communication apparatus 2400 may further include a storage module 2403, configured to store program code and data of the communication apparatus 2400.

In an instance, when the communication apparatus is used as a STA or a chip applied to a STA, and performs the steps performed by the STA in the foregoing method embodiments, the transceiver module 2402 is configured to support communication with an AP and the like, and the transceiver module specifically performs a sending action and/or a receiving action that are/is performed by the STA in FIG. 7 and FIG. 8. For example, the transceiver module supports the STA in performing step 703 and/or another process of the technology described in this specification. The processing module 2401 may be configured to support the communication apparatus 2400 in performing the processing actions in the foregoing method embodiments. For example, the processing module supports the STA in performing another process of the technology described in this specification.

For example, the transceiver module 2402 is configured to receive a trigger frame, where the trigger frame includes a user information field corresponding to one or more users, and the one or more users include a first user using joint source and channel coding; and the first user corresponds to a plurality of user information fields, and a user information field corresponding to the first user indicates a layer frequency domain resource of the first user at a source layer; or the first user corresponds to one user information field, and the one user information field corresponding to the first user indicates a total frequency domain resource of the first user at all source layers. The transceiver module 2402 is configured to send a trigger-based physical layer protocol data unit of the first user, where the trigger-based physical layer protocol data unit includes joint source and channel coding data on a layer frequency domain resource of the first user.

For another example, the transceiver module 2402 is configured to receive a trigger frame, where the trigger frame indicates a bandwidth allocated to a user, and the trigger frame further indicates at least one of the following: The trigger frame is a single-user trigger frame, and the user performs joint source and channel coding transmission through a non-trigger-based physical layer protocol data unit. The transceiver module 2402 is configured to send the non-trigger-based physical layer protocol data unit, where the non-trigger-based physical layer protocol data unit includes joint source and channel coding data on the bandwidth allocated to the user.

In an instance, when the communication apparatus is used as an AP or a chip applied to an AP, and performs the steps performed by the AP in the foregoing method embodiments, the transceiver module 2402 is configured to support communication with a STA and the like, and the transceiver module specifically performs a sending action and/or a receiving action that are/is performed by the AP in FIG. 7 and FIG. 8. For example, the transceiver module supports the AP in performing step 701 and/or another process of the technology described in this specification. The processing module 2401 may be configured to support the communication apparatus 2400 in performing processing actions in the foregoing method embodiments. For example, the processing module supports the AP in performing another process of the technology described in this specification.

For example, the processing module 2401 is configured to generate a trigger frame, where the trigger frame includes a user information field corresponding to one or more users, and the one or more users include a first user using joint source and channel coding; and the first user corresponds to a plurality of user information fields, and a user information field corresponding to the first user indicates a layer frequency domain resource of the first user at a source layer; or the first user corresponds to one user information field, and the one user information field corresponding to the first user indicates a total frequency domain resource of the first user at all source layers. The transceiver module 2402 is configured to send the trigger frame. The transceiver module 2402 is configured to receive a trigger-based physical layer protocol data unit of the first user, where the trigger-based physical layer protocol data unit includes joint source and channel coding data on a layer frequency domain resource of the first user.

For another example, the processing module 2401 is configured to generate a trigger frame, where the trigger frame indicates a bandwidth allocated to a user, and the trigger frame further indicates at least one of the following: The trigger frame is a single-user trigger frame, and the user performs joint source and channel coding transmission through a non-trigger-based physical layer protocol data unit. The transceiver module 2402 is configured to send the trigger frame. The transceiver module 2402 is configured to receive the non-trigger-based physical layer protocol data unit, where the non-trigger-based physical layer protocol data unit includes joint source and channel coding data on the bandwidth allocated to the user.

In a possible implementation, when the STA or the AP is a chip, the transceiver module 2402 may be an input/output interface, a pin, a circuit, or the like. For example, the input/output interface may be configured to input to-be-processed data to a logic circuit, and may output a processing result of the logic circuit to the outside. During specific implementation, the input/output interface may be a general-purpose input/output (general purpose input/output, GPIO) interface, and may be connected to a plurality of peripheral devices (for example, a display (LCD), a camera (camera), a radio frequency (radio frequency, RF) module, and an antenna). The input/output interface is connected to the processor through a bus.

The processing module 2401 may be a logic circuit, and the logic circuit may execute stored instructions, so that the chip performs the method in either the embodiment shown in FIG. 7 or the embodiment shown in FIG. 8. It may be understood that the instructions may be stored in the storage module.

The storage module may be a storage module inside the chip, for example, a register or a cache. Alternatively, the storage module may be a storage module located outside the chip, for example, a read-only memory (Read-Only Memory, ROM), another type of static storage device that can store static information and instructions, or a random access memory (Random Access Memory, RAM).

It should be noted that a function corresponding to each of the logic circuit and the input/output interface may be implemented by using a hardware design, may be implemented by using a software design, or may be implemented by a combination of software and hardware. This is not limited herein.

An embodiment of this application further provides a communication apparatus, including a processor and a transceiver. The processor is configured to support the communication apparatus in performing either the embodiment shown in FIG. 7 or the embodiment shown in FIG. 8 The transceiver is configured to support communication between the communication apparatus and a communication apparatus other than the communication apparatus. The communication apparatus may further include a memory. The memory is configured to be coupled to the processor, and the memory stores program instructions and data that are necessary for the communication apparatus. The transceiver may be integrated into the communication apparatus or independent of the communication apparatus. This is not limited herein. For example, in a distributed scenario, the transceiver may be disposed remotely and independently of the communication apparatus.

An embodiment of this application further provides a chip. The chip includes at least one logic circuit and an input/output interface. The logic circuit is configured to read and execute stored instructions. When the instructions are run, the chip is enabled to perform either the embodiment shown in FIG. 7 or the embodiment shown in FIG. 8

An embodiment of this application further provides a computer-readable storage medium. The computer-readable storage medium stores a computer program, the computer program includes program instructions, and when the program instructions are executed by a computer, the computer is enabled to perform either the embodiment shown in FIG. 7 or the embodiment shown in FIG. 8

An embodiment of this application further provides a computer program product including instructions. When the computer program product runs on a computer, the computer is enabled to implement either the embodiment shown in FIG. 7 or the embodiment shown in FIG. 8.

The foregoing units described as separate parts may or may not be physically separate, and parts displayed as units may or may not be physical units, may be located at one location, or may be distributed on a plurality of network units. Some or all of the units may be selected based on an actual requirement, to achieve the objectives of the solutions in embodiments of this application. In addition, network element units in embodiments of this application may be integrated into one processing unit, or each of the units may exist alone physically, or two or more units may be integrated into one unit. The integrated unit may be implemented in a form of hardware, or may be implemented in a form of a software network element unit.

When the integrated unit is implemented in the form of the software network element unit and sold or used as an independent product, the integrated unit may be stored in a computer-readable storage medium. Based on such an understanding, an essentially contributing part in the technical solutions of this application, or all or some of the technical solutions may be embodied in a form of a software product. The computer software product is stored in a storage medium, and includes several instructions for instructing a computer device (which may be a personal computer, a terminal device, a cloud server, a network device, or the like) to perform all or some of the steps of the method described in the foregoing embodiment of this application. The foregoing storage medium includes any medium that can store program code, such as a USB flash drive, a removable hard disk, a read-only memory (ROM, Read-Only Memory), a random access memory (RAM, Random Access Memory), a magnetic disk, or an optical disc. The foregoing descriptions are merely specific implementations of this application, but are not intended to limit the protection scope of this application. Any modification or replacement readily figured out by a person skilled in the art within the technical scope disclosed in this application shall fall within the protection scope of this application. Therefore, the protection scope of this application shall be subject to the protection scope of the claims.

1. A communication method, wherein the method comprises:
generating a trigger frame, wherein the trigger frame comprises a user information field corresponding to one or more users, and the one or more users comprise a first user using joint source and channel coding; and
the first user corresponds to a plurality of user information fields, and a user information field corresponding to the first user indicates a layer frequency domain resource of the first user at a source layer; or
the first user corresponds to one user information field, and the one user information field corresponding to the first user indicates a total frequency domain resource of the first user at all source layers;
sending the trigger frame; and
receiving a trigger-based physical layer protocol data unit of the first user, wherein the trigger-based physical layer protocol data unit comprises joint source and channel coding data on a layer frequency domain resource of the first user.

2. The method according to claim 1, wherein the trigger frame indicates that there is a user using joint source and channel coding in the one or more users.

3. The method according to claim 1, wherein
the trigger frame further comprises a common information field, and the common information field indicates that there is the user using joint source and channel coding in the one or more users; or
the trigger frame further comprises a special user information field, and the special user information field indicates that there is the user using joint source and channel coding in the one or more users.

4. The method according to claim 1, wherein
a user information field corresponding to the first user indicates a modulation and coding scheme of the first user at a source layer; or
a user information field corresponding to the first user indicates the first user to select a modulation and coding scheme of a source layer.

5. The method according to claim 1, wherein a user information field corresponding to the first user further indicates that the first user uses joint source and channel coding transmission.

6. The method according to claim 1, wherein the first user corresponds to a plurality of user information fields, and that the first user uses joint source and channel coding transmission is indicated by the plurality of user information fields corresponding to the first user that use a same association identifier field.

7. The method according to claim 1, wherein the first user corresponds to the plurality of user information fields, a number of source layers of the first user is equal to a number of user information fields that use the same association identifier field, and the association identifier field indicates an association identifier of the first user.

8. The method according to claim 1, wherein the first user corresponds to one user information field; and
the one user information field corresponding to the first user further indicates at least one of the following: a number of source layers of the first user or a layer frequency domain resource of the first user at each source layer; or
a layer frequency domain resource of the first user at each source layer is a predefined frequency domain resource.

9. The method according to claim 1, wherein the first user corresponds to the plurality of user information fields; and
the trigger-based physical layer protocol data unit comprises a first signal field of the first user, the first signal field of the first user indicates at least one of the following: a joint source and channel coding parameter of one source layer corresponding to the first user, and a joint source and channel coding parameter shared by all the source layers of the first user, and the first signal field of the first user is on a layer frequency domain resource at the one source layer corresponding to the first user; or
the trigger-based physical layer protocol data unit comprises a data field of the first user, the data field of the first user indicates at least one of the following: a joint source and channel coding parameter of one source layer corresponding to the first user, and a joint source and channel coding parameter shared by all the source layers of the first user, and the data field of the first user is on a layer frequency domain resource at the one source layer corresponding to the first user.

10. The method according to claim 1, wherein the first user corresponds to the one user information field; and
the trigger-based physical layer protocol data unit comprises a first signal field of the first user, the first signal field of the first user indicates at least one of the following: a joint source and channel coding parameter of one source layer corresponding to the first user, and a joint source and channel coding parameter shared by all the source layers of the first user, and the first signal field of the first user is on a layer frequency domain resource at the one source layer corresponding to the first user; or
the trigger-based physical layer protocol data unit comprises a first signal field of the first user, the first signal field of the first user indicates at least one of the following: a joint source and channel coding parameter of each source layer of the first user, and a joint source and channel coding parameter shared by all the source layers of the first user, and the first signal field of the first user is on the total frequency domain resource of the first user at all the source layers; or
the trigger-based physical layer protocol data unit comprises a first signal field of the first user, the first signal field of the first user comprises a signal A field and at least one signal B field, the signal A field is on the total frequency domain resource of the first user at all the source layers, one signal B field is on a layer frequency domain resource of one source layer corresponding to the first user, the signal A field indicates a joint source and channel coding parameter shared by all the source layers of the first user, and the one signal B field indicates a joint source and channel coding parameter of the one source layer corresponding to the first user.

11. The method according to claim 9, wherein the first signal field of the first user further indicates at least one of the following: a number of all source layers of the first user and an identifier of a source layer corresponding to the first user.

12. The method according to claim 10, wherein
the first signal field of the first user further comprises a layer resource assignment field, and the layer resource assignment field indicates at least one of the following: the number of source layers of the first user and the layer frequency domain resource of the first user at each source layer; or
the layer frequency domain resource of the first user at each source layer is the predefined frequency domain resource.

13. The method according to claim 9, wherein
the first signal field of the first user is after a universal signal field and before a short training field, the universal signal field is on the total frequency domain resource of the first user at all the source layers, and the short training field is on the layer frequency domain resource at the one source layer corresponding to the first user; or
the first signal field of the first user is after a long training field and before a data field, and the long training field and the data field are on the layer frequency domain resource at the one source layer corresponding to the first user.

14. A communication apparatus, wherein the communication apparatus comprises a transceiver and at least one processor;
the processor is configured to generate a trigger frame, wherein the trigger frame comprises a user information field corresponding to one or more users, and the one or more users comprise a first user using joint source and channel coding; and
the first user corresponds to a plurality of user information fields, and a user information field corresponding to the first user indicates a layer frequency domain resource of the first user at a source layer; or
the first user corresponds to one user information field, and the one user information field corresponding to the first user indicates a total frequency domain resource of the first user at all source layers;
the transceiver is configured to send the trigger frame; and
the transceiver is configured to receive a trigger-based physical layer protocol data unit of the first user, wherein the trigger-based physical layer protocol data unit comprises joint source and channel coding data on a layer frequency domain resource of the first user.

15. The communication apparatus according to claim 14, wherein the trigger frame indicates that there is a user using joint source and channel coding in the one or more users.

16. The communication apparatus according to claim 14, wherein
the trigger frame further comprises a common information field, and the common information field indicates that there is the user using joint source and channel coding in the one or more users; or
the trigger frame further comprises a special user information field, and the special user information field indicates that there is the user using joint source and channel coding in the one or more users.

17. The communication apparatus according to claim 14, wherein
a user information field corresponding to the first user indicates a modulation and coding scheme of the first user at a source layer; or
a user information field corresponding to the first user indicates the first user to select a modulation and coding scheme of a source layer.

18. The communication apparatus according to claim 14, wherein a user information field corresponding to the first user further indicates that the first user uses joint source and channel coding transmission.

19. A communication apparatus, wherein the communication apparatus comprises a transceiver module;
the transceiver module is configured to receive a trigger frame, wherein the trigger frame comprises a user information field corresponding to one or more users, and the one or more users comprise a first user using joint source and channel coding; and
the first user corresponds to a plurality of user information fields, and a user information field corresponding to the first user indicates a layer frequency domain resource of the first user at a source layer; or
the first user corresponds to one user information field, and the one user information field corresponding to the first user indicates a total frequency domain resource of the first user at all source layers; and
the transceiver module is configured to send a trigger-based physical layer protocol data unit of the first user, wherein the trigger-based physical layer protocol data unit comprises joint source and channel coding data on a layer frequency domain resource of the first user.

20. A communication apparatus according to claim 19, wherein the trigger frame further comprises a common information field, and the common information field indicates that there is the user using joint source and channel coding in the one or more users; or
the trigger frame further comprises a special user information field, and the special user information field indicates that there is the user using joint source and channel coding in the one or more users.
